(19) United States
(12) Patent Application Publication
(10) Pub. No.: US 2014/0017454 A1
(43) Pub. Date: Jan. 16, 2014

(54) Thin Films with Micro-Topologies Prepared by Sequential Wrinkling

(71) Applicant: MASSACHUSETTS INSTITUTE OF TECHNOLOGY, Cambridge, MA (US)

(72) Inventors: Mary Cunningham Boyce, Winchester, MA (US); Karen K. Gleason, Cambridge, MA (US); Jose Luis Yague, Somerville, MA (US); Jie Yin, Somerville, MA (US); Shabnam Raayai Ardakani, Cambridge, MA (US)

(73) Assignee: Massachusetts Institute of Technology, Cambridge, MA (US)

(21) Appl. No.: 13/795,209

(22) Filed: Mar. 12, 2013

Related U.S. Application Data
(60) Provisional application No. 61/671,327, filed on Jul. 13, 2012.

(51) Int. Cl. C09D 5/28

(52) U.S. Cl. CPC C09D 5/28
USPC 428/187; 427/171; 427/535

(57) ABSTRACT

One aspect of the invention relates to a method of forming a micro- or nano-pattern on the surface of a composite material. The pattern may be a herringbone pattern with a jog angle of greater than or less than 90° or a graded wrinkled pattern. The micro- or nano-patterns on composite materials produced by the methods may be used to modulate, confer or control thin film material properties; as the basis for thickness measurements; to enhance light extraction in OLED; to enhance light harvest in opto-electronic devices; to tune adhesion properties, wetting, and friction of surfaces; to reduce fluid flow drag; and for anti-fouling purposes.

### RELATED APPLICATIONS

This application claims the benefit of priority to U.S. Provisional Patent Application Ser. No. 61/671,327, filed Jul. 13, 2012, the contents of which are hereby incorporated by reference.

### BACKGROUND OF THE INVENTION

Wrinkling of thin coatings bonded to a compliant substrate is often found in natural systems and has recently been exploited in synthetic systems for a variety of applications. Wrinkled surface topologies occur when out-of-plane bending of a coating is energetically favored over compression. This phenomenon is the planar equivalent to the well-known problem of buckling of a beam on an elastic foundation. The wrinkling phenomenon has been observed on the micro-scale using thermal deposition of a 50-nm-thick gold film on a polydimethylsiloxane (PDMS) substrate, where the expansion mismatch of the two materials was used to generate compression within the film. Subsequently, experimental and theoretical studies have explored multifunctional micro/nano-scale surface patterns by harnessing spontaneous buckling of bilayer composite systems composed of a wide range of hard and soft materials.

Upon constrained thermal expansion or swelling of a thin film on a compliant substrate, equi-biaxial compressive strains are induced in the film producing two-dimensional (2D) wrinkled herringbone patterns with a 90° jog angle. For this equi-biaxial strain case, the herringbone possesses a deterministic short wavelength along one direction satisfying a minimum energy condition but an undetermined long wavelength along the other direction (see FIG. 1 for the definition of both wavelengths and jog angle). In addition, equi-biaxial-strain-induced herringbone morphologies are experimentally observed to occur only in small regions of a film, whereas large areas consist of disordered labyrinth patterns with randomly oriented wrinkles. Sequentially releasing equi-biaxially stretched PDMS film with an oxygen plasma treated surface layer results in the formation of an ordered herringbone pattern with jog angles of 90°; however, simultaneous release of prestrain, leads to a material having a labyrinth pattern. The transition from disordered to ordered patterns by means of sequential loading opens a new avenue for creating 2D ordered wrinkling patterns. However, the underlying wrinkling mechanism has yet to be identified and quantified, and hence the predictive design of ordered topologies remains a challenge.

There exists a need for micro- or nano-patterned surfaces and methods of forming them, wherein an ordered wrinkled topology is produced deterministically. In addition, it would be useful to be able to actively reconfigure the geometrical structure of a surface; for example, materials that reversibly switch from patterned to flat would be useful in the field of stretchable electronics.

### SUMMARY OF THE INVENTION

One aspect of the invention relates to a composite material, wherein the composite material comprises a substrate with a coated surface; the coated surface comprises a coating material; and the coated surface comprises a topographic pattern. In certain embodiments, the topographic pattern is a deterministic pattern. In certain embodiments, the topographic pattern is a herringbone pattern. In certain embodiments, the topographic pattern is a herringbone pattern; and the herringbone pattern comprises a jog angle that is not about 90°. In certain embodiments, the topographic pattern is a herringbone pattern; and the herringbone pattern comprises a jog angle from about 5° to less than about 90°. In certain embodiments, the topographic pattern is a herringbone pattern; and the herringbone pattern comprises a jog angle from greater than about 90° to less than about 180°. In certain embodiments, the substrate is homogeneous, heterogeneous or a composite. In certain embodiments, the substrate is soft. In certain embodiments, the substrate is pliable or porous. In certain embodiments, the thickness of the coating material is substantially uniform. In certain embodiments, the coating material is adhered to the substrate.

Another aspect of the invention relates to a method of making a wrinkled composite material, comprising the steps of: providing a substrate; stretching the substrate in a first dimension and a second dimension, thereby forming a stretched substrate; coating a surface of the stretched substrate with a material, wherein the stretched substrate is coated by initiated chemical vapor deposition or thermal deposition of the material onto the stretched substrate, thereby forming a stretched substrate with a coated surface; releasing from the first dimension the stretch from the stretched substrate with a coated surface, releasing from the second dimension the stretch from the stretched substrate with a coated surface, wherein releasing the stretch causes the coated surface to buckle, thereby forming a composite material with a wrinkled coated surface. In certain embodiments, the stretched substrate is coated by initiated chemical vapor deposition of the material onto the stretched substrate.

A third aspect of the invention relates to a method of making a composite material, comprising the steps of: providing a substrate; stretching the substrate in a first dimension and a second dimension, thereby forming a stretched substrate; exposing a surface of the stretched substrate to plasma, thereby forming a stretched substrate with an enhanced number of radical species on its surface; contacting with a gaseous silane the surface of the stretched substrate enhanced in radical species, thereby forming a covalent bond between the silane and the substrate; coating the surface of the stretched substrate with a material, wherein the stretched substrate is coated by initiated chemical vapor deposition or thermal deposition of the material onto the stretched substrate, thereby forming a stretched substrate with a coated surface; releasing from the first dimension the stretch from the stretched substrate with a coated surface, releasing from the second dimension the stretch from the stretched substrate with a coated surface, wherein releasing the stretch causes the coated surface to buckle, thereby forming a composite material with a coated surface. In certain embodiments, the stretched substrate is coated by initiated chemical vapor deposition of the material onto the stretched substrate.

A fourth aspect of the invention relates to a composite material, wherein the composite material comprises a substrate and a coated surface with non-uniform cross-sectional geometries; the coated surface comprises a trapezoidal geometry with uniform coating thickness; and the coated surface comprises a topographic pattern. In certain embodiments, the graded geometry of a trapezoid leads to a graded stress distribution across the coated surface, and the graded stress leads to a graded strain distribution. In certain embodiments, the topographic pattern is a graded pattern due to graded strain distribution. In certain embodiments, the graded pattern is a non-uniform pattern across different locations; and the non-uniform pattern comprises gradually decreasing out-of-plane amplitudes. In certain embodiments, the non-uniform pattern comprises gradually increasing wavelength. In certain embodiments, the formation of the graded pattern is a sequential process; and the sequential process comprises the occurrence of wrinkles one by one. In certain embodiments, the graded pattern comprises a tunable surface topography, and the surface topography is adjusted by tailoring different taper angles. In certain embodiments, the geometry of a coated surface is trapezoid, or anti-trapezoid, or combination of trapezoids or anti-trapezoids.

A fifth aspect of the invention relates to a method of dynamically tuning the surface topography through mechanical strain. In certain embodiments, the two-dimensional wrinkled micro-patterns are dynamically tuned under cyclic mechanical loading and unloading. In certain embodiments, a bi-axially pre-stretched PDMS substrate is coated with a strain-free stiff polymer deposited by iCVD. In certain embodiments, applying a mechanical release-restretch cycle to the system results in a variety of dynamic and tunable wrinkled geometries. In certain embodiments, the surface topography is reversible after cyclic release-restretch processes.

The invention also includes a method of determining the modulus of a coating film on any one of the aforementioned composite materials, comprising the steps of: measuring the first wavelength of the coating; and measuring the second wavelength or the third wavelength of the coating. In certain embodiments, further comprising the steps of: calculating a ratio of the first wavelength to the second wavelength or third wavelength; and calculating the modulus from the ratio.

The invention also includes a method of measuring the thickness of a coating film on any one of the aforementioned composite materials, comprising the steps of: measuring the first wavelength; and measuring the second wavelength or the third wavelength. In certain embodiments, further comprising the steps of: calculating a ratio of the first wavelength to the second wavelength or third wavelength; calculating the modulus from the ratio; and calculating the thickness from the modulus.

Another aspect of the invention relates to an article comprising an aforementioned composite material. In certain embodiments, the article is a light-emitting diode (LED). In certain embodiments, the article is an organic light-emitting diode (OLED). In certain embodiments, the article is a liquid crystal display (LCD). In certain embodiments, the article is an opto-electronic device. In certain embodiments, the article is a bright enhancement film (BEF). In certain embodiments, the article is a flow drag-reducing coating. In certain embodiments, the article is substantially resistant to biofouling. In certain embodiments, the article is useful for guiding self-driven motion of water droplets.

### BRIEF DESCRIPTION OF THE FIGURES

FIG. 1 depicts a schematic illustration of wrinkling through biaxial mechanical strain: a PDMS is first biaxially stretched, followed by the deposition of an p(EGDA) or p(HEMA) polymer film on the stretched PDMS using iCVD followed by release of the biaxial strain. The transition from disordered (a) to ordered (b, c, d) herringbone patterns with different jog angles is realized by changing from simultaneous to sequential release of biaxial strains. (a) Upon simultaneous release of equi-biaxial prestrain of 10%, disordered surface patterns are formed on p(EGDA) coating with thickness t of 100 nm. (b) Upon sequential release of equi-biaxial prestrain of 20%, the ordered herringbone pattern with a jog angle α of 90° occurs (p(EGDA) coating thickness t=100 nm). (c) Upon sequential release of the larger strain ε_{y}=20% first followed by release of the smaller strain εₓ=10%, the ordered herringbone pattern with a jog angle larger than 90° (α≈105°) occurs (p(EGDA) coating t=300 nm). (d) Upon sequential release of the smaller strain εₓ=20% first followed by release of the larger strain ε_{y}=30%, the ordered herringbone pattern with a jog angle less than 90° (α≈61°) occurs (p(EGDA) coating t=400 nm). The corresponding FEM simulations are shown on the right column. For clarity, only the film surface is shown.

FIG. 2 depicts the evolution of herringbone jog angle with the sequential released biaxial strain ratio ε^{2nd}/ε^{1t} Left column: intermediate wrinkling patterns during the second release of smaller prestrain (εₓ=2.5%) followed by the first fully released prestrain (ε_{y}=2.5%). Right column: intermediate wrinkling patterns during the second release of larger prestrain (ε_{y}=5%) after the first release of smaller prestrain (εₓ=2.5%).

FIG. 3 depicts (a) schematic illustration of lateral buckling of beams with sinusoidal cross section rested on substrates. The composite wavy column shown on the left takes the same wavelength and amplitude as those formed by the first release of prestrain along y-axis. When subjected to uni-axial compression along x-axis, straight columns laterally buckle into sinusoidal shapes along x-axis shown on the right. (b) Schematic illustration of parameters (wavelength, amplitude and jog angle) characterizing the geometry of a herringbone pattern. The out-of-plane profile is represented by z (x, y)=A, cos {2π/λₘ (y+Aₗ cos (2πx/λₗ))}, where Aₛ and Aₗ are the out-of-plane amplitude of short wave along y-axis and in-plane amplitude of long wave along x-axis, respectively. λₘ and λₗ are the intermediate and long wavelengths defined as the distance between two adjacent jogs along the y-axis and x-axis, respectively. Two dependent parameters are the short wavelength λₛ (the perpendicular distance between two adjacent contours) and the jog angle α with λₛ=λₘ sin(α/2) and α=π−2 tan⁻¹(π²Aₗ/2λₗ). SEM images of herringbone patterns over macroscopic areas created through (c) sequential release of equi-biaxial prestrain of 20% on 200 nm p(EGDA) coating (SEM area: 1 mm×0.8 mm), (d) sequential release of non-equi-biaxial prestrain with ε^{1st}=20% and ε^{2nd}=30% on 400 nm p(EGDA) coating (SEM area: 1.5 mm×1.2 mm).

FIG. 4 depicts the comparison between FEM, theory, and experiments for multiple wavelengths (a) and amplitudes (b) of herringbones and 1D wrinkles for different p(EGDA) coating thickness upon sequential release of equi-biaxial prestrain of 10% or release of uni-axial prestrain of 10%. SEM images of wrinkled p(EGDA) coating with thickness of 200±10 nm (c), 400±12 nm (d), and 540±18 nm (e). (f) SEM images of wrinkled p(HEMA) coating with thickness of 300±10 nm.

FIG. 5 depicts a schematic illustration of conventional OLED consisting of planar multilayers (top) and proposed new OLEDs with 1-D and 2-D wrinkled morphologies for enhancing light extraction.

FIG. 6 depicts possible light paths when interacting with a bright enhancement film (BEF): 1. Total internal reflection and recycled of the ray. 2. Light refracted to the display panel. 3. Refraction reentered and recycled of the ray. 4. Loss of the ray.

FIG. 7 depicts a schematic illustration of anisotropic friction properties when sliding in different directions of 2-D herringbone patterns.

FIG. 8 depicts flow velocity contours of fluid transporting along the wrinkle (left) and perpendicular to the wrinkles (right).

FIG. 9 depicts dynamic tuning of herringbone patterns by stretching the wrinkled patterns simultaneously (a) and sequentially (b); (c) Morphology evolution of stretching the wrinkled herringbone patterns along the zig-zag wrinkles.

FIG. 10 depicts the stress-strain curves of herringbone patterns along x and y-axis directions.

FIG. 11 depicts the variation of total strain energy density (U) normalized by the strain energy density of prestretched substrate Uₒ=εₛε²/(1−vₛ) with different normalized RVE size by λ for simultaneous release (a) and sequential release (b). The respective normalized long wavelength by λ versus RVE size is shown on the right axis. The insets show the simulated wrinkling patterns with different RVE sizes.

FIG. 12 depicts (a) the variation of jog angle of herringbone patterns with the release of equi-biaxial prestrain of 2.5%, the insets show the intermediate buckling patterns upon simultaneous and sequential release; (b, c, d, e, f, and g) the comparison of resulting 2D buckling patterns upon simultaneous and sequential release of the equi-biaxial prestrain at a value of 2.5% (b, e), 5% (c, f), and 10% (d, g); and (h and i) the variation of out-of-plane amplitude Aₛ (h) and in-plane amplitude Aₗ (i) with the sequential release of prestrain.

FIG. 13 depicts the comparison of simulated 2D buckling patterns upon simultaneous and sequential release of the non-equi-biaxial prestrain with the biaxial ratio of 3 (a, c and e), and 4 (b, d and f), where the prestrain along x is fixed as 5%. ε_{y}^{pre} is released first for c and d, and is released second for e and f.

FIG. 14 depicts SEM images of large area of ordered herringbone patterns on EGDA coating with thickness of 200 nm upon the sequential release of non-equi-biaxial prestrains, where a larger prestrain of 30% is first released and then a smaller prestrain of 20% is released sequentially.

FIG. 15 depicts the examination of the prestretching strain effect on the 1D wrinkle wavelength and amplitude in Eq. (1) through FEM and experiment. (a) wrinkle wavelength versus prestrain for coating thickness of 200 nm. (b) wrinkle amplitude versus prestrain for coating thickness of 200 nm.

FIG. 16 depicts an illustration of dynamic tuning wrinkling patterns through strain releasing and reloading using FEM simulations: (a) A stress-free p(EGDA) polymer thin coating is deposited on a biaxially stretched PDMS (not shown in figure), (b) first release of strain along x-axis leads to 1D wrinkles; (c) sequential release of strain along y-axis results in 2D zig-zag herringbone patterns; (d) 2D wrinkles transit to 1D wrinkles upon restretching along y-axis and finally becomes non-wrinkled flat surface after stretching along x-axis.

FIG. 17 depicts wrinkling patterns of EGDA coating on PDMS substrates upon sequential release of biaxial strains with a strain of 10% along x-axis and a strain of 25% along y-axis. Figures a to c correspond to release in the x-axis, and d to f correspond to release in the y-axis. The scale bar (25 μm) applies to all images. The inset graphs show the Fourier Transform image analysis of the samples.

FIG. 18 depicts the evolution of wrinkling patterns through sequential restretching of wrinkled EGDA coating on PDMS substrates along two directions to the original stretching strain of 10% along x-axis and 25% along y-axis. Figures a to c correspond to restretch in y-axis, and d to f correspond to restretch in the x-axis. The scale bar (25 μm) applies to all images. The inset graphs show the Fourier Transform image analysis of the samples.

FIG. 19 depicts a) wrinkling pattern obtained after stretching of 10% along x-axis and 25% along y-axis and sequential release for second time. b) Chaotic wrinkling pattern obtained after stretching of 10% along x-axis and 25% along y-axis and simultaneous release. c) Chaotic wrinkling pattern obtained after stretching of 10% along x-axis and 25% along y-axis and simultaneous release for second time. The inset graphs show the Fourier Transform image analysis of the samples.

FIG. 20 depicts the evolution of simulated patterns after sequential or simultaneous restretch of a labyrinth pattern; the small icon figures show the corresponding FT images. (a) Chaotic pattern created upon simultaneous release of equi-biaixal strain of 10% along x and y axis direction; (b) intermediate pattern after first restretched strain of 10% along y axis; (c) final pattern after simultaneous biaxial restretch of 10%; (d) final pattern after second restretched strain of 10% along x axis direction.

FIG. 21 depicts a comparison of wrinkle wavelength (squares) and amplitude (circles) between experiments (data points), FEM simulation (dashed lines), and analytical models (solid lines) upon sequential releasing and reloading of biaxial strain.

FIG. 22 depicts (a) Simultaneous loading and unloading of equi-biaxial strain of 10% with normalized loading time. (b) Corresponding normalized strain energy in the film with loading time, (c) Simultaneous loading and sequential unloading of equi-biaxial strain of 10% along x- (right) and y-axis (left); (d) Corresponding normalized strain energy in the film with loading time.

FIG. 23 depicts a demonstration of how changing uniform geometry to graded geometry alters the wrinkles, from uniform wrinkles to graded wrinkles.

FIG. 24 depicts differences in stress distribution in the coating for uniform and graded geometries.

FIG. 25 depicts the trend in the amplitude and wavelength of the wrinkles along the length of the coating.

FIG. 26 depicts experimental results on graded wrinkling using a trapezoidal coating with thickness of 300 nm and short and long edges of 0.6 and 1.2 mm, respectively, over 25 mm of length, created by releasing a uni-axial prestrain of 20%. Images on the left of the figure, are taken with a 3D Surface profilometer, demonstrating wrinkles at three representative locations; two regions near the short and long edges of the trapezoid, and the third one near the center of the film.

FIG. 27 depicts the relationship between the critical wavelength of the wrinkles and taper angles

FIG. 28 depicts possible combinations of geometry which can be used for patterning surfaces.

FIG. 29 depicts exemplary wavelength definitions for uniform wrinkling (a) and for graded wrinkling (b).

### DETAILED DESCRIPTION OF THE INVENTION

### Overview

Wrinkled surface patterns in soft materials have become increasingly important across a broad range of applications, including stretchable electronics, microfluidics, thin-film material properties measurement, tunable wetting and adhesion, and photonics. Thermal and swelling mismatch of thin films on compliant substrates produces equi-biaxial compression in the film, resulting in a buckling instability which produces a labyrinth wrinkling pattern with isolated regions of ordered herringbone pattern. The short wavelength of these patterns is a minimum energy structure, however, the longer wavelengths are not deterministic.

Wrinkling patterns with uniform wavelength and amplitude are widely observed and extensively studied; however, if a film employs a non-uniform cross-sectional geometry such as a trapezoidal shape, the resulted wrinkling wavelength and amplitude are no longer spatially uniform, which leads to a variety of new graded morphological patterns with non-uniform features and multi-functional applications in engineering.

In certain embodiments, the invention relates to a method of constructing highly ordered herringbone patterns with prescribed long and short wavelengths using a sequential wrinkling strategy. The deterministic patterns may be formed over areas of larger than 1 cm². Furthermore, herringbone patterns with a prescribed zig-zag turning (i.e., a jog) angle are obtained upon sequential wrinkling of non-equi-biaxial prestrain, where jog angles less than 90° are obtained for the first time. In certain embodiments, the sequential wrinkling strategy also provides a method for measuring thin-film mechanical properties simply through the metrology of the long and short wrinkle wavelength without measurement of film thickness. In certain embodiments, the invention relates to materials comprising these patterns. In certain embodiments, the invention relates to materials and/or devices made by these methods.

In certain embodiments, the invention relates to a method of dynamically tuning the highly ordered herringbone patterns through controlling mechanical strain. In certain embodiments, without requiring traditional lithographic tools and masks, the formation of wrinkled patterns through dynamic control of mechanical strain offers a cost-effective and reliable method for rapidly generating tunable and ordered micro-patterned surfaces over large area. In certain embodiments, changing the patterns is achieved simply by altering the degree of pre-stretched strain, the coating thickness, or the coating modulus, rather than fabricating a new lithographic mask. In certain embodiments, the dynamic tuning of wrinkling patterns to switch from patterned to flat surfaces is reversible upon release or re-stretch of the substrate.

In certain embodiments, the invention relates to extra tunable long wavelength and asymmetric herringbone patterns with jog angle different from 90°. In certain embodiments, the invention relates to applications in tunable wetting, adhesion, and friction properties. In certain embodiments, the invention relates to altering boundary layers in fluid flow, microfluidic channels. In certain embodiments, the invention relates to applications in enhancing light extraction in OLED and brightness of optical devices.

In certain embodiments, the invention relates to the deterministic design of ordered wrinkled topologies through a sequential wrinkling strategy. In certain embodiments, the invention relates to thin polymeric films synthesized from monomers including ethylene glycol diacrylate (EGDA) and 2-hydroxyethyl methacrylate (HEMA) on PDMS substrates. In certain embodiments, the invention involves initiated chemical vapor deposition (iCVD) for the deposition of thin polymeric coatings without use of solvents to obtain wrinkles. In certain embodiments, iCVD yields a conformal thin coating on virtually any substrate, giving a controllable thickness and tunable structural, mechanical, thermal, wetting, and swelling properties. In certain embodiments, the invention relates to the use of the iCVD technique to form a variety of ordered deterministic herringbone patterns through the wrinkling of polymeric coatings on PDMS substrates.

In certain embodiments, the invention relates to the investigation of the sequential buckling mechanisms underpinning the ordered patterns. In certain embodiments, the invention relates to a simplified theoretical model to predict the geometry of the ordered herringbone pattern.

In certain embodiments, the invention relates to a method of measuring the elastic modulus of a thin film or the elastic modulus of a thin film or both.

In certain embodiments, the invention relates to a method of constructing 1-D ordered graded patterns with non-uniform amplitude and periodicity across different locations. By coating a trapezoidal shape of thin film with uniform thickness on a soft substrate, graded patterns are generated through gradient wrinkling. Under the same compression, the trapezoidal-shaped film undergoes non-uniform stress distribution due to its continuously varied cross-sectional geometry along the compression direction, which leads to the gradient strain distribution in the film. Since the occurrence of wrinkles and their geometries are related with the strain level in the film, the film undergoes a sequential wrinkling process, where the first wrinkle occurs with the highest out-of-plane amplitude at the largest strain location. As the strain in the film increases, other wrinkles develop and grow sequentially depending on their strain and thus locations.

In certain embodiments, the invention relates to self-driven movement of water-droplet with unbalanced wetting contact angles.

### Deterministic Herringbone Patterns: Tunable Jog Angle

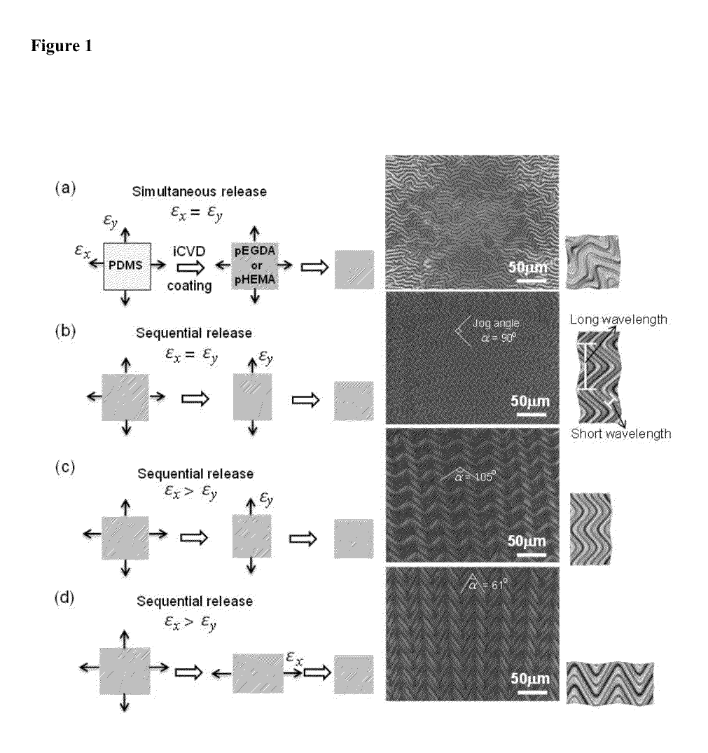

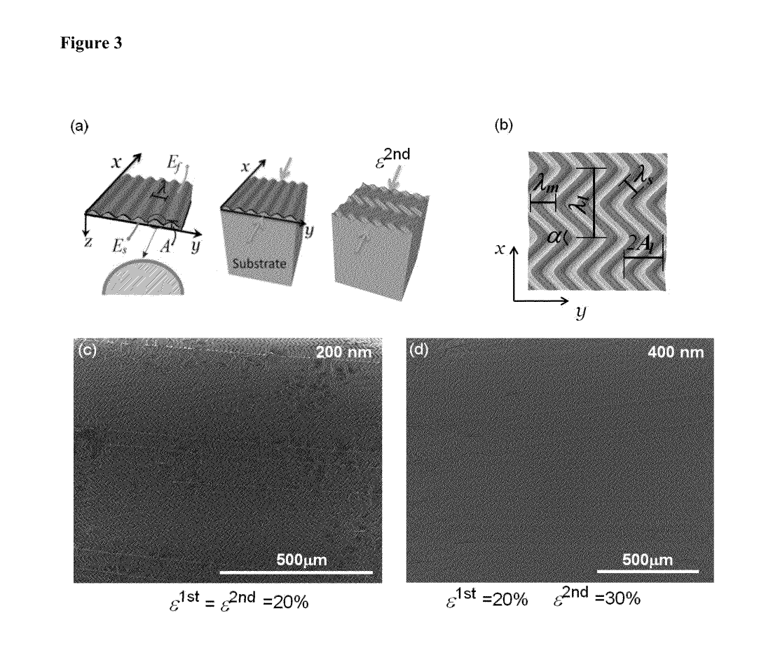

FIG. 1 shows a schematic illustration of the wrinkling procedures and the resulting wrinkling patterns obtained upon simultaneous and sequential release of biaxial stretching prestrains. Upon simultaneous release of equi-biaxial strain of εₓ=ε_{y}≈10%, disordered labyrinth patterns are observed on p(EGDA) coating (t=100 nm) (FIG. 1a), such a labyrinth pattern is more energetically favorable upon the release of the strain energy in all directions. The transition from disordered to ordered patterns is observed through the sequential release of the equi-biaxial prestrain in one direction followed by the release of the strain in the other direction. FIG. 1b shows an ordered herringbone pattern with a jog angle of 90° for p(EGDA) coating (t=200 nm) created upon the sequential release of an equi-biaxial strain of ≈20% and such a pattern persists over a large area (>1 cm² where a 2 mm² region of this large area is shown later in FIG. 3c).

The ability to control the jog angle α is obtained through the sequential release of non-equi-biaxial prestrain (εₓ‡ε_{y}). FIG. 1c shows an ordered herringbone pattern with α larger than 90°, where the larger prestrain (εₓ≈20%) is first released and then the smaller prestrain (ε_{y}≈10%) is released. We note that simultaneous release of such a biased biaxial prestrain will produce the same ordered herringbone pattern with its jog angle always being larger than 90° regardless of the biaxial strain ratio. However, through sequential release of the smaller prestrain (ε_{y}≈20%) first followed by release of the larger prestrain (εₓ≈30%), jog angles less than 90° are created as shown in FIG. 1d (α=61°. It is observed in these experiments that such an ordered pattern persists over a large area. It should be noted that this is the first time that ordered herringbone patterns with jog angles of less than 90° are created.

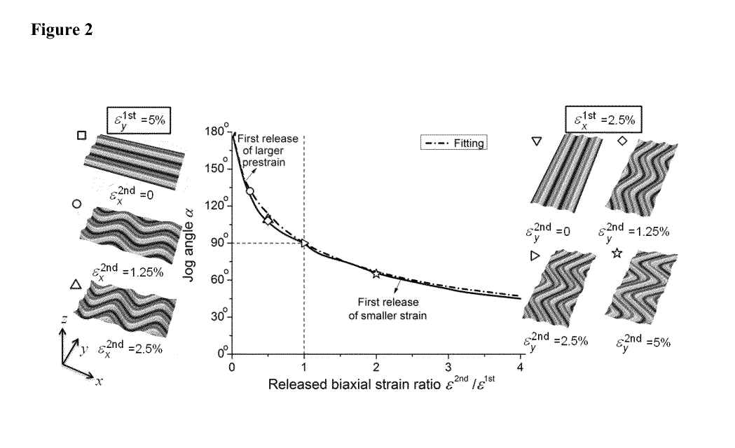

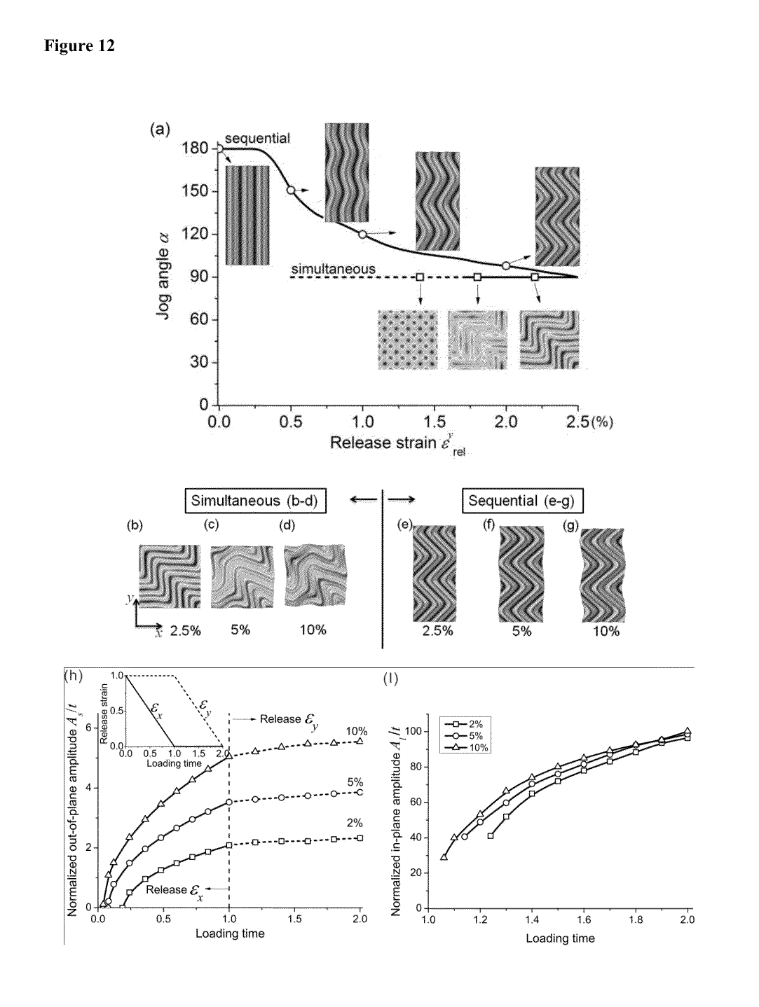

Micromechanical models using the finite element method (FEM) are carried out to reveal the underlying buckling mechanisms as well as the evolution of wrinkling patterns during simultaneous and sequential release of prestrains (See, for example, Examples 4 and 5). Upon simultaneous release of a small equi-biaxial prestrain of 2.5%, the film undergoes equi-biaxial compression and the resulting herringbone pattern shows a jog angle of 90° (FIG. 11a), consistent with herringbone patterns reported in the literature using thermal deposition and solvent swelling approaches. For sequential release of the same equi-biaxial prestrain, the final pattern is obtained through two intermediate steps (FIG. 2): first, after release of the prestrain in the x-axis, out-of-plane buckling occurs and a 1D wrinkle forms; second, upon release of the second prestrain in the y-axis, the 1D waves laterally buckle within the plane, forming the herringbone pattern with jog angle of 90° (FIG. 12a). The out-of-plane amplitude of the wrinkle remains nearly constant during the lateral buckling (Example 6). Furthermore, simulation shows that for simultaneous release, the long wavelength of the herringbone is not defined by an energy minimum and is indeterminate (Example 5). This finding is consistent with the wide range of long wavelength observed in previous simultaneous release experiments. However, for sequential release, the long wavelength is deterministic, satisfying a minimum strain energy condition (Example 5). A structural mechanics model for the long wavelength is provided later.

At relatively larger prestrains (εₓ=ε_{y}±5%), the sequential wrinkling strategy provides a robust method for creating ordered herringbone patterns in contrast to the simultaneous release of equi-biaxial prestrain. Simulation shows that for simultaneous release, when the prestrain is increased to 5% (Figure S2c) or 10% (FIG. 1a), the herringbone pattern becomes distorted and thus disordered. This outcome is consistent with the labyrinth patterns observed in corresponding experiments under a prestrain of 10% (FIG. 1a). However, upon sequential release of the prestrain, the ordered herringbone pattern persists even at a relatively large strain of 10% (FIG. 12g) and 20% (FIG. 1b), which agrees with our experimental observation (FIG. 1b).

A jog angle α=90° is universally found for all equi-biaxial strain induced wrinkling, which implies that the jog angle is independent of the material properties of the system and only related to the ratio of the biaxial strain state. Hence, altering the strain state provides the ability to manipulate the jog angle as shown in FIG. 2, where the biaxial strain ratio is defined as the ratio of the second released strain ε^{2nd} to the first released strain ε^{1st}. For the same non-equi-biaxial prestrains (e.g., εₓ=2.5% and ε_{y}=5% shown in FIG. 2), simulation shows that releasing the larger prestrain first leads to final herringbone patterns with α>90°, which agrees with the experimental observation (FIG. 1c). Releasing the smaller strain εₓ=2.5% first and then releasing the larger strain ε_{y}=5% leads to final herringbone patterns with α<90°. As the second strain ε_{y}^{2nd} increases from 0 to 5%, when ε_{y}^{2nd}/εₓ^{1st}<1, intermediate herringbone patterns with α>90° are first formed; when ε_{y}^{2nd}/εₓ^{1st}=1, α=90°; when ε_{y}^{2nd}/εₓ^{1st}>1, α<90° (right column of FIG. 2). This trend agrees with the experimental observation for sequential release of the non-equi-biaxial prestrain as shown in FIG. 1d and the jog angle decreases with an increase in the biaxial prestrain ratio. From the angle information in FIG. 2, an equation for predicting a can be approximated as

$$α \approx π - 2 {tan}^{- 1} [ {( {ɛ}^{2 nd} / {ɛ}^{1 st} )}^{\frac{3}{5}} ] , \qquad ( 1 )$$

which provides a design guideline for quantitatively controlling 2D herringbone patterns.

### Deterministic Herringbone Patterns: Determined Long Wavelength

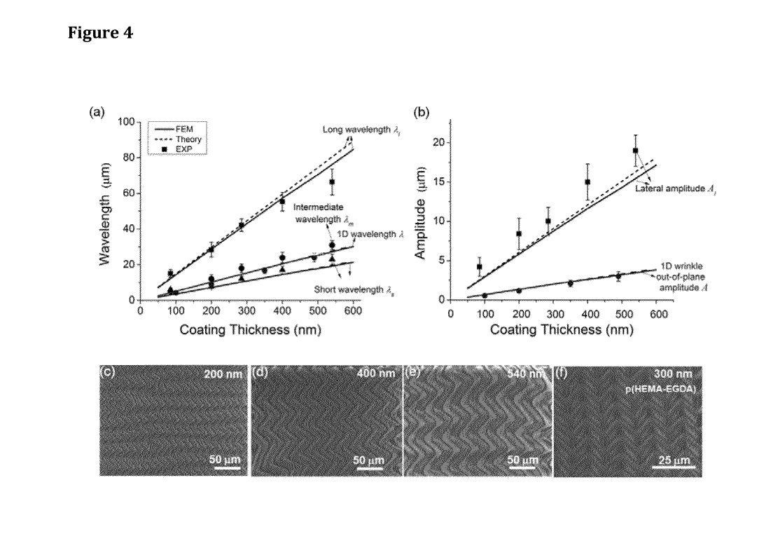

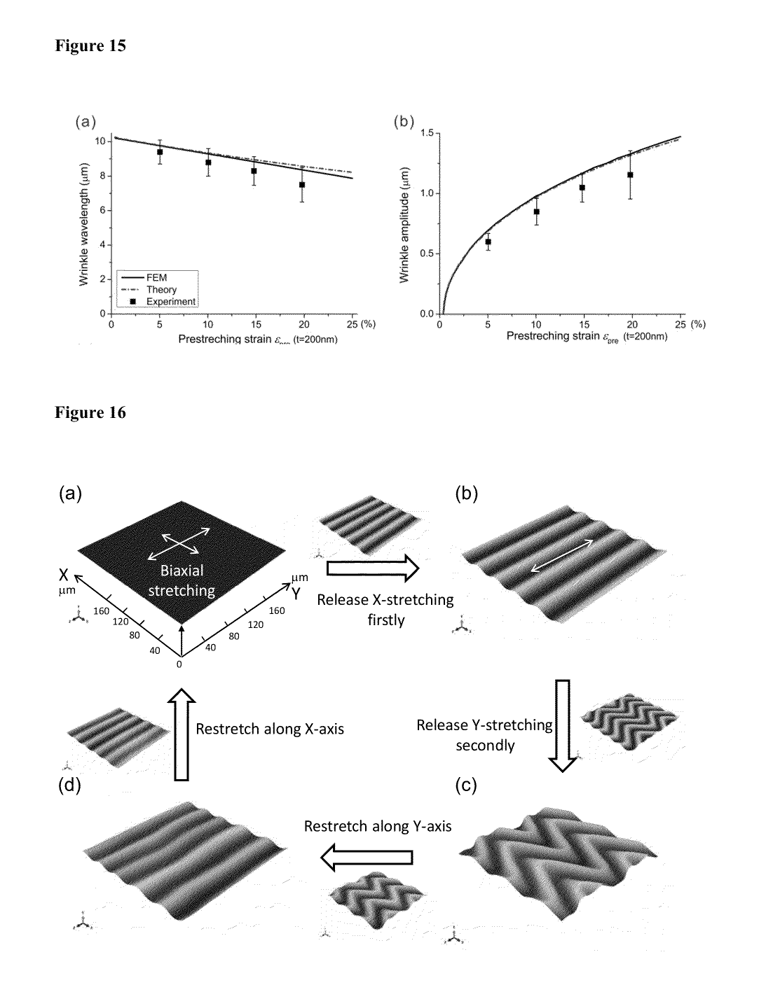

The formation of the herringbone pattern due to sequential unloading is deterministic and provides a minimum energy configuration (see Example 5). As schematically illustrated in FIG. 3a, the theoretical prediction for the deterministic geometry of herringbone patterns (FIG. 3b) is obtained through a simplified model:
First, release of the first strain produces the 1D wrinkle pattern; each wrinkle can be considered to be a composite beam with a one-half sinusoidal cross-section (composed of the coating film and underneath substrate) bonded to an elastic foundation, where the cross-sectional shape is determined from the wavelength 2 and amplitude A of the 1D wrinkles upon the first strain release ε^{1st},

$$\begin{matrix}λ = \frac{2 π {t ( {\overline{E}}_{f} / 3 {\overline{E}}_{s} )}^{\frac{1}{3}}}{1 + {ɛ}^{1 st}} & ( 2 ) \\ A = \frac{t \sqrt{{ɛ}^{1 st} / {ɛ}_{cr} - 1}}{\sqrt{1 + {ɛ}^{1 st}}} & ( 3 )\end{matrix}$$

where Ē_{f}=E_{f}/(1−v_{f}²) and Ēₛ=Eₛ/(1−vₛ²) are the plane strain modulus of the film and substrate with v_{f} and vₛ being the respective Poisson's ratio. ε_{cr}=(3Ēₛ/Ē_{f})^{2/3}/4 is the critical buckling strain of the 1D wrinkle and ε_{cr}=0.37% for p(EGDA) coating. Equation (2) and (3) are validated for the wrinkling of p(EGDA) coating on PDMS (FIG. 4a, FIG. 4b, and FIG. 15), which provides a predictive methodology to design the 1D wrinkled morphologies by tailoring the film modulus and thickness, and substrate modulus as well as prestrain.
Second, upon release of the second pre-strain, the composite beams are taken to buckle under the constraint of being bonded to the compliant substrate. Using the expression for the in-plane bending for a composite column on an elastic foundation (Equation S3), the long wrinkle wavelength λₗ (FIG. 3b) and the critical sequential buckling strain ε_{cr}¹ upon the release of the second prestrain ε^{2nd} can be obtained through classical buckling perturbation analysis (see Example 9 for details), which are found as when considering the finite deformation of the column)

$$\begin{matrix}{λ}_{l} = 2.06 π {t ( 1 - {v}_{f}^{2} )}^{\frac{1}{4}} {( \frac{{\overline{E}}_{f}}{3 {\overline{E}}_{s}} )}^{\frac{1}{2}} \frac{g ( {ɛ}^{1 st} )}{1 + {ɛ}^{2 nd}} & ( 4 ) \\ {ɛ}_{cr}^{l} = \frac{0.05 π}{\sqrt{1 - {v}_{f}^{2}}} {( \frac{3 {\overline{E}}_{s}}{{\overline{E}}_{f}} )}^{\frac{2}{3 }} h ( {ɛ}^{1 st} ) & ( 5 )\end{matrix}$$

where g(ε^{1st}) and h(ε^{1st}) are defined as g(ε^{1st})=(3\sqrt{ε^{1st}−ε_{cr}}/π−1)^{1/4} and h(ε^{1st})=g²/\sqrt{ε^{1st}/ε_{cr}−1}. For small prestrain (e.g., ε^{1st}<5%), g(ε^{1st}) can be approximated as 1 with the error less than 5%. Equation (4) shows the long wavelength is proportional to the coating thickness t since ε_{cr} is independent of the film thickness t. In addition, λₗ decreases with increasing second prestrain. The critical sequential buckling strain (Equation (5)) is found to be independent of the film thickness and to be dependent of the first released prestrain. From the geometry of a herringbone pattern, the lateral amplitude Aₗ is governed by the jog angle and the long wavelength, i.e.

$${A}_{l} = \frac{2 {λ}_{l} cot ( α / 2 )}{{π}^{2}} \qquad ( 6 )$$

Equation (6) demonstrates that Aₗ is proportional to λₗ and thus is proportional to t. In addition, Aₗ is dependent of the jog angle and thus the strain ratio. Specially, when the jog angle is equal to 90°, Aₗ becomes 2λₗ/π² and the value of Aₗ is smaller than that of λₗ (i.e., Aₗ≈0.22λₗ).

The theoretical model is further examined in simulations and experiments. FIG. 4 shows the wavelength and amplitude of herringbones created through sequential release of equi-biaxial prestrain as a function of different coating thicknesses. As shown in FIG. 4a, the linear increase of the long wavelength with coating thickness in Equation 4 agrees with the experiments of p(EGDA) coating on PDMS substrate and related FEM simulations. The intermediate wavelength λₘ is equal to the 1D wrinkle wavelength λ in Equation 2 (i.e., λₘ=λ), which agrees with both experiments and FEM simulation. The geometrically dependent short wavelength λₛ is given by λₛ=λₘ sin(α/2), which is consistent with simulations. FIG. 4b shows the value of lateral amplitude Aₗ is about 4-5 times larger than that of out-of-plane amplitude of 1D wrinkle. The linear increase of Aₗ with the coating thickness in Equation (6) is consistent with experiments.

### Graded Patterns

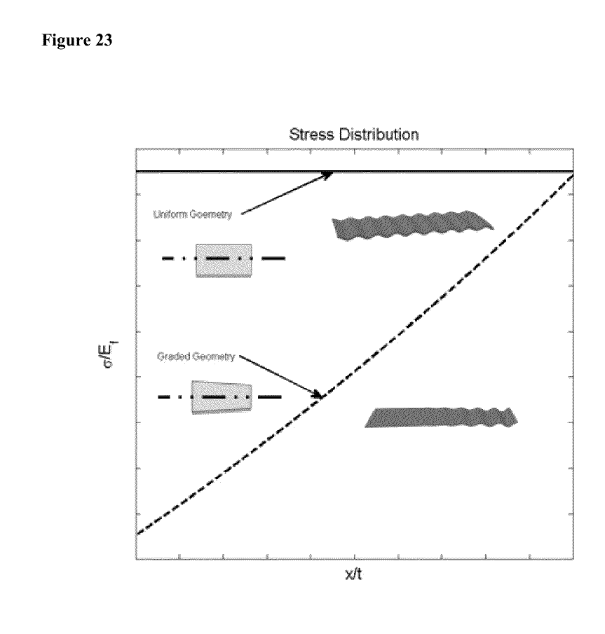

FIG. 23 shows the comparison of stress distribution in the film with rectangle and trapezoid shape under the same uni-axial compression along x-axis. As shown in FIG. 23, for rectangle shape, the cross-section geometry along x-axis is uniform and thus renders uniform stress distribution in the film, which results in the wrinkled profiles with uniform amplitude and wavelength. However, for trapezoidal shape, the geometry is not uniform any more but with its y-axis width gradually and continuously increasing along x-axis. Under the same compression force, varied cross-section geometry gives a non-uniform stress distribution, i.e. the strain in the film varies at different locations. Since both the amplitude and wavelength of wrinkles depend on the strain in the film, unlike the uniform wrinkles found in the rectangle film, trapezoidal film presents wrinkles with different amplitude and wave lengths along the x-axis after buckling.

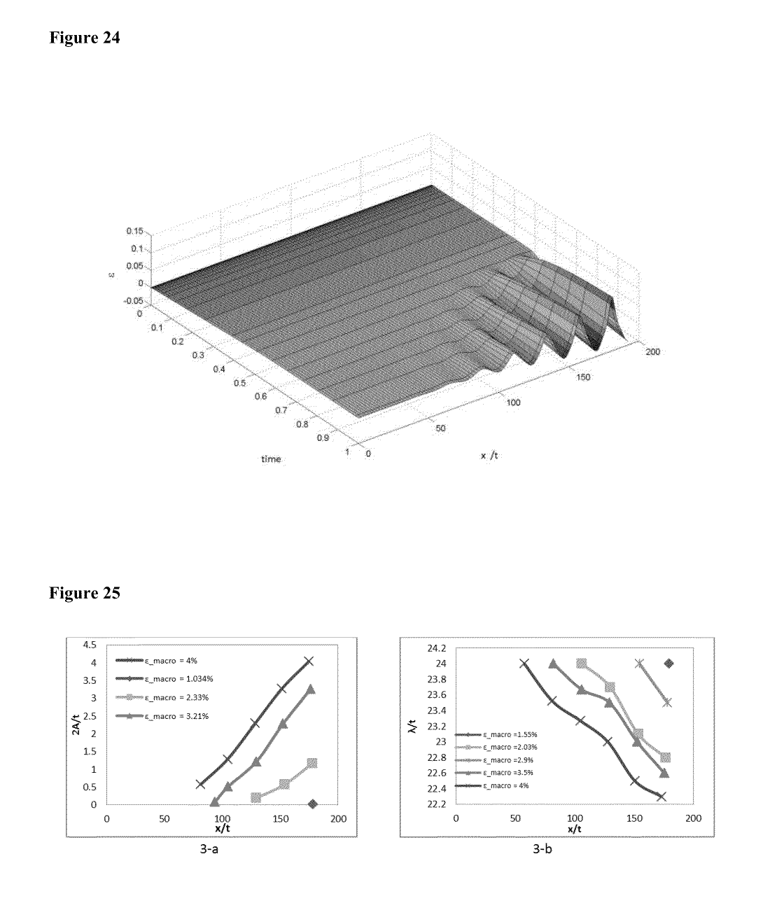

Since the critical buckling strain is the same across the trapezoidal film, the gradient strain distribution in the film leads to the sequential wrinkling process, where wrinkles show up one by one as the film is being compressed or wrinkles disappear sequentially as the film is being restretched. During release of the pre-stretch, the film is under compression, the first wave or the “initial wave” shows up first at the shortest edge where it has the highest stress. Then by increasing the compressive loading on the film upon further release, the consequent wrinkles show up one by one. As part of this sequential process, it is noticed that the critical wave length at which wrinkles occur, is the same for each of the waves equaling to the initial critical wavelength (critical wavelength of the first wave). FIG. 24 shows how the strain profile evolves in time as the film and the compliant matrix undergo compression (t is the thickness of the film and E is the strain in film). As seen in the figure, the wrinkling process is a sequential process starting where the stress is the highest and as the film is compressed more, the wrinkles show up one by one along the length. During restretching of the film, graded wrinkling shows a sequential disappearance of the waves, where the wave occurring last during release disappears first and then followed by the others.

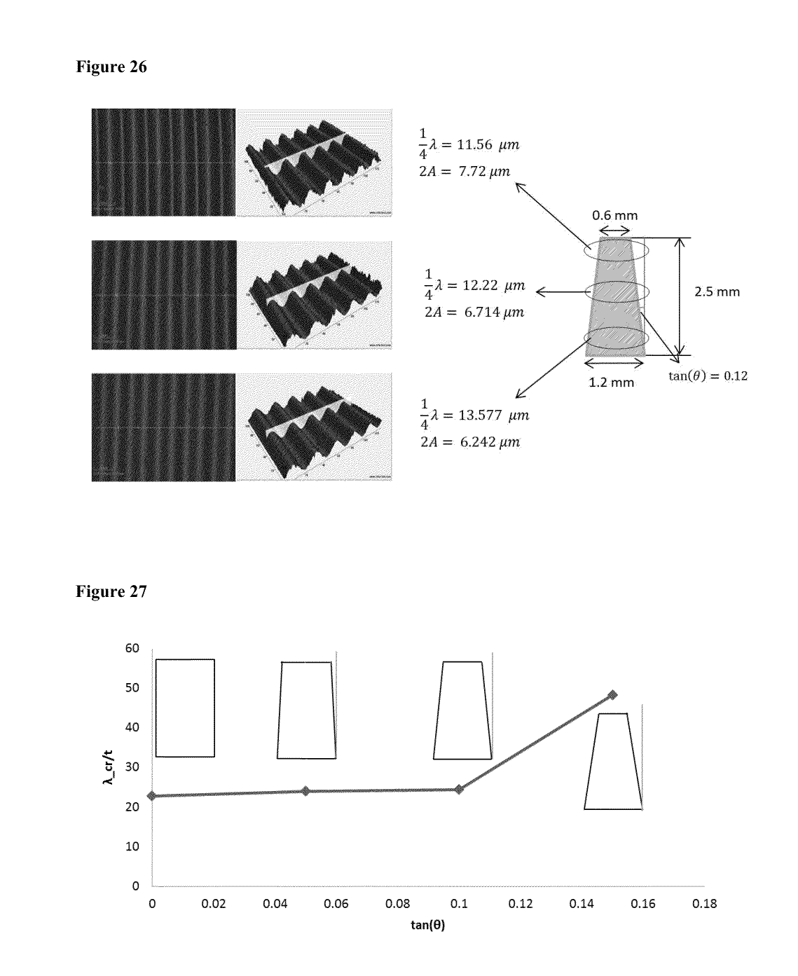

In graded wrinkling, the finite element simulation shows that the resulting wrinkled profile has a non-uniform geometry in terms of varied amplitude and wavelength. Since the strain distribution in the film is non-uniform, both amplitude and wavelength of each wrinkle depend on the width of the film. As shown in FIG. 25, as the width of the film increases, at the same released strain, the amplitude of the wrinkles decreases along the length of the film (FIG. 25a), while the wave length of the waves increases (FIG. 25b). When the strain is further released, the amplitude of all the wrinkles increases whereas their wavelength decreases as shown in FIG. 25. The non-uniform geometry of wrinkles through graded wrinkling is validated by experiments, where a trapezoidal-shaped EGDA film is coated on a PDMS soft substrate with uniform coating thickness of 300 nm. FIG. 26 shows the 3D optical images of wrinkles at three representative locations, with two regions near the short and long edge of a trapezoid, and the third one near the center of the film. Experimental results show that when the width of the film increases from 0.6 mm to 1.2 mm, the resulting wavelength of the corresponding wrinkles increases from about 46 μm to 54 μm, whereas the resulting amplitude of the corresponding wrinkles at the same location decreases from 3.86 μm to 3.12 μm, which is consistent with the numerical simulations.

Another important parameter in characterizing a trapezoidal shape is the taper angle, which can be tailored to manipulate the wrinkling patterns on a trapezoidal film. FIG. 27 shows the relationship between the wrinkling wavelength and taper angles. As the taper angle increases, the critical wavelength also increases as shown in FIG. 27. Specially, when the taper angle decreases to 0, the trapezoidal shape becomes a rectangle one and its corresponding critical wavelength is a little lower when compared to that of a trapezoidal one.

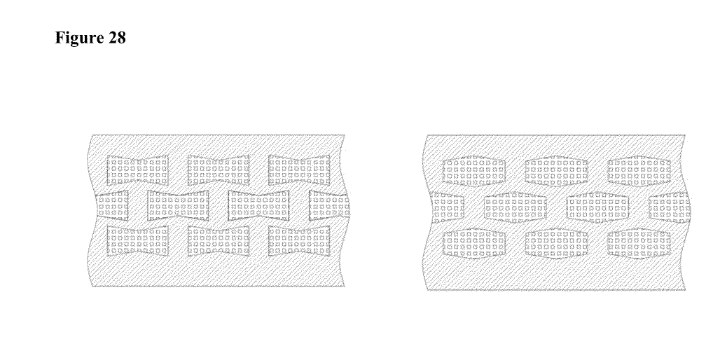

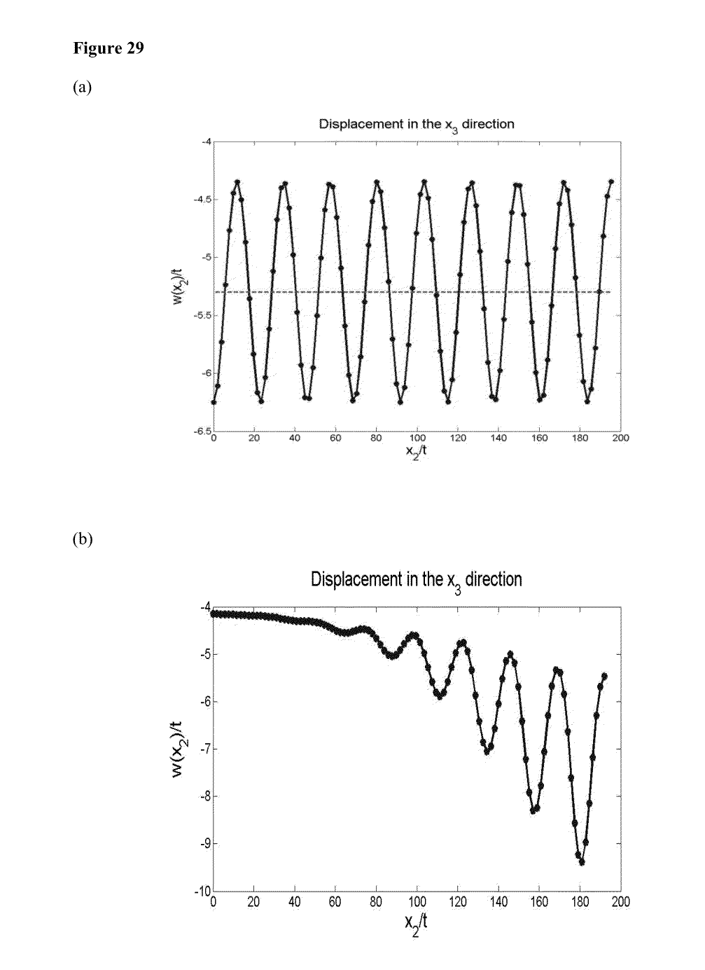

Furthermore, different combination of geometries can be put together to create different surface patterns with graded wrinkling. By coating the compliant matrix with repeating geometrical features such as trapezoids or anti-trapezoids, different combinations of surface patterns can be created. FIG. 28 shows 2 examples of possible geometry combination which can be used for patterning surfaces. The hashed area represents the compliant matrix while the square-hashed area represents the places where the film is coated.

### Exemplary Uses

Measurement of Thin Film Material Properties and Thickness

The deterministic long wavelength predicted by Equation (4) through sequential release of biaxial prestrain can find potential applications in the measurement of material properties of the thin film coatings. Since both the intermediate wavelength λₘ and the long wavelength λₗ are proportional to the film thickness t, for small equi-biaxial prestrain, the ratio of λₗ/λₘ gives

$$\frac{{λ}_{l}}{{λ}_{m}} \approx 1.22 {( 1 - {v}_{f}^{2} )}^{\frac{1}{4 }} {( \frac{{\overline{E}}_{f}}{3 {\overline{E}}_{s}} )}^{\frac{1}{6}} \qquad ( 7 )$$

The above equation shows that the wavelength ratio is only related to the modulus ratio between the film and substrate. Thus through the measurement of the ratio of λ₁/λₘ, the modulus of the film ε_{f} can be estimated as

$${E}_{f} \approx \frac{0.91 {\overline{E}}_{s}}{\sqrt{1 - {v}_{f}^{2}}} {( \frac{{λ}_{l}}{{λ}_{m}} )}^{6} \approx \frac{0.11 {\overline{E}}_{s}}{\sqrt{1 - {v}_{f}^{2}}} {( \frac{{λ}_{l}}{{λ}_{s}} )}^{6} \qquad ( 8 )$$

Measurement of thin film properties through measurement of the 1D wrinkle wavelength (i.e., E_{f}=3(1−v_{f}²)Ēₛ(λ/2πt)³ from Equation (2)) has been used by others but the film thickness must be known. However, for very thin films, the thickness is difficult to measure and hence gives substantial measurement error. Through the sequential release of the load, the film property can be obtained by only measuring the two wrinkle wavelengths without the measurement of the film thickness.

As one example for demonstrating the measurement of film modulus through sequential wrinkling, a HEMA-based copolymer with a relatively lower Young's modulus is deposited on PDMS substrate with coating thickness of 200 nm. Upon the sequential release of equi-biaxial prestrain of 10%, a herringbone pattern is observed in the hydrophilic swellable layer (FIG. 4f), where the intermediate wavelength is λₘ9.2±0.6 μm and long wavelength is λₗ=20.2±1.1 μm and the ratio of two wavelengths gives λₗ/λₘ≈2.2. By assuming a Poisson's ratio for p(HEMA) of 0.4, from Equation (8) the Young's modulus of p(HEMA) E_{f} can be readily predicted giving E_{f}⁼183 MPa. This value is consistent with the value E_{f}=168±24 MPa obtained through the measurement of the short wavelength and the coating thickness (i.e., Equation (2)). FIG. 4f also confirms that the wrinkling processes described here can be extended to additional iCVD functional polymeric surface layers.

In addition, once the modulus of a film is known the thickness of the film can be obtained from the determined measured wavelength because the multiple wavelengths are associated with or a function of the thickness. The thickness of the film can be obtained from Equation (2) or (4) on the expression of the short or long wavelength.

Enhancing Light Extraction in OLED Through Buckling

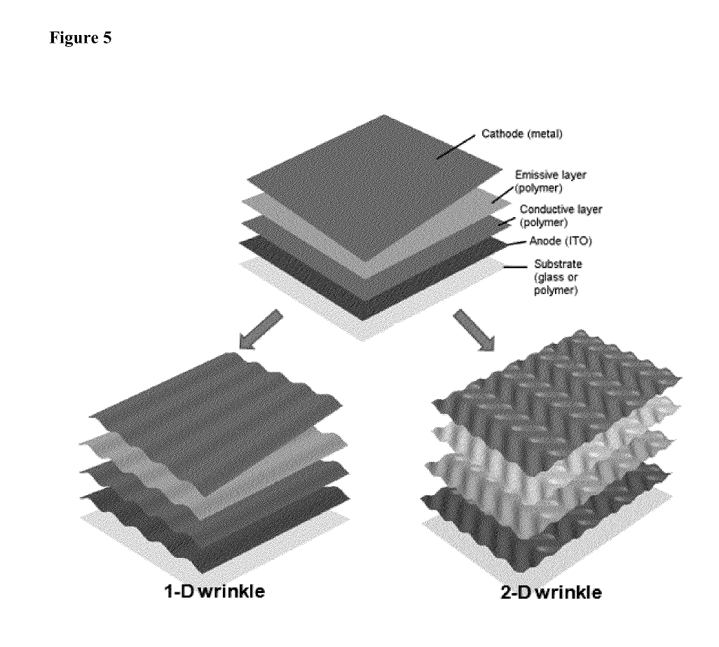

Organic light-emitting devices (OLEDs) have attracted intense interests with their broad applications in flat panel displays and solid-state lighting. A typical OLED consists of metal cathode, emissive and conductive organic layer, anode (indium tin oxide, ITO), and glass substrate. Electroluminescent (EL) light is emitted from the emissive layer and the light is outputted through the transparent glass substrate. However, in conventional OLEDs, 80% of the photons are trapped in the anode and glass substrate due to the total internal reflection resulted from the large refractive index mismatch between the organic layer, glass substrate, and air, which produces a low out-coupling efficiency (i.e., the ratio of surface emission to all emitted light) of around 20%. Such a low out-coupling efficiency has become a major limitation on the high efficiency levels of OLEDs. Recent studies showed that the presence of random wrinkles formed in the metal cathode and emissive layer could greatly enhance the light extraction efficiency in white OLEDs, where the mismatched thermal deformation renders equi-biaxial compressive stress in the cathode and leads to the labyrinth wrinkling patterns. Compared with the thermal deposition method, mechanical stretching is more cost-effective and dynamically controllable. In addition, the sequential wrinkling strategy provides a useful means for dynamically manipulating the large-area 2-D ordered herringbone patterns, which could be effectively employed as a dynamic tunable periodic structure to extract light in OLED towards air. The two-wavelength and tunable jog angles could provide waveguide light propagation along a wide range of directions and spectral range (FIG. 5). Similarly, the 1-D sinusoidal wrinkles could be used to provide light propagation along a directed direction with a specified spectral range, which has great application in enhancing the light extraction in full color OLEDs depending on the controllable 1-D wrinkle wavelength and amplitude (FIG. 5).

Enhancing Light Harvesting in Opto-Electronic Devices

Due to their geometry wrinkle-patterned surfaces can increase the external quantum efficiency of polymer photovoltaic devices. Thus, semiconducting thin films can be deposited on top of a compliant substrate and, after buckling, both labyrinth and herringbone patterns can be created. These structures can trap and waveguide light better than flat surfaces. Moreover, patterned topologies can increase the range of light absorption, resulting in an enhancement of light harvesting.

Enhancing Brightness of Optical Devices

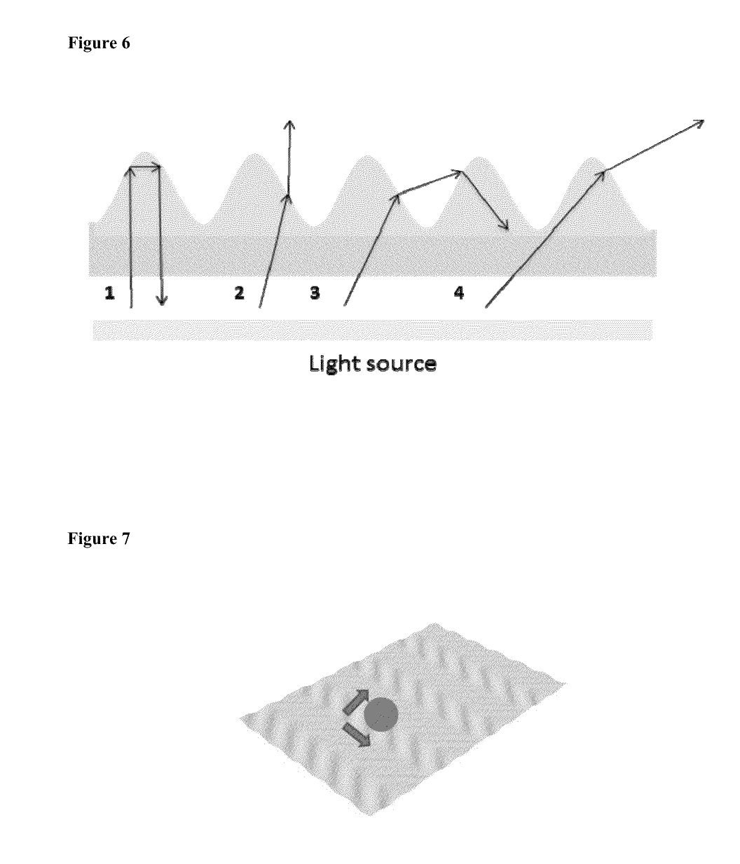

In those technologies using light guides techniques, i.e., LCD displays, excess refraction of the light source can result in loss of power. However, patterned thin films can be used to enhance the brightness of these optical devices. So far, bright enhancement films (BEF) have used wave- or prism-shape pattern to increase brightness in optical devices. A very interesting possibility is the use of more complex pattern to enhance this effect. The formation of 2D micro-topologies can enable a large recycle of the refracted light and thus a lesser loss of power. The characteristic herringbone pattern can increase the effective area of polymer exposed to refracted light and thus, more rays can be redirected for recycling (case 3 in FIG. 6) for enhancing the brightness in the device.

In certain embodiments of the invention, an optical film is provided to enable control of light scattering. The polymeric layer displays a sinusoidal-shape interphase that can prevent loss consumption in optical devices. Vinyl-based materials deposited onto a compliant substrate can be used to create a pattern through stretching and releasing of the system. Adjusting the characteristics of the materials, i.e., mechanical properties, thickness, it is possible to control the features of this sinusoidal-shape pattern.

The characteristic round-shape of the thin film enables to recycle most of the flux refracted away of the device to increase the efficiency. Depending on the incident angle striking the pattern, the light can experiment either refraction or total internal reflection that can be recycled to enhance the brightness of the display panel (FIG. 6).

Moreover, the refractive index of the material plays a key role in this device. When a ray of light travels from a medium with a high refractive index to a medium with a low refractive index, and strikes at an angle larger than a critical angle, then, the ray reflects and remains confined in the medium with the higher refractive index. This phenomenon is known as total internal refraction and can help to recycle the light (case 1 in FIG. 6). Therefore, iCVD can be used to tune the refractive index of the polymeric layer to enhance this process. It has been demonstrated that copolymerization of two vinyl monomers can result in a change of the refractive index. When the monomers have a different refractive index, copolymerization of both of them leads to a polymer with a new refractive index that ranges between the refractive index of the monomers depending on the polymer composition. By adjusting the monomer feed into the reactor, iCVD enables the control in the reactivity of the monomers, and thus in the final composition of the polymer.

In certain embodiments, the invention relates to a method of manufacturing bright enhancement films (BEF) for optical applications by patterning 2D micro-topologies on a surface.

Tunable Adhesion and Wetting Properties of Micro-Wrinkled Surface

The adhesion and wetting properties of a surface are related to its surface roughness. When the size of the patterning on a surface goes down to the micro- or even nano-scale, the surface morphology plays a dominant role in determining their surface-related properties such as adhesion and wetting ability. Previous studies have shown that with the presence of 1-d micro-scale wrinkles on a hydrophilic surface, the surface can be transited to a hydrophobic one. Furthermore, the 1-D micro-wrinkle can also enhance the adhesion of two micro-patterned surfaces when compared to smooth ones. By using the sequential wrinkling strategy, 2-D deterministic and dynamically tunable wrinkling micro-patterns with multiple controllable wavelengths, amplitude and turning angles provide a more effective way to tailor the adhesion and wetting properties of the patterned surface.

Moreover, the wetting properties of a surface can be tuned by controlling the hydrophilicity or hydrophobicity of the polymeric thin film coating. iCVD techniques allow the use of a wide range of monomers with variations in their pendant functionalities, which enables deposition of coatings with hydrophilic or hydrophobic properties influenced by the pendant functionalities.

Tunable Friction Properties of Micro-Wrinkled Surface

Until now, little is known on how wrinkles affect the friction properties of a surface. In certain embodiments, the invention relates to wrinkles as an effective way to tailor and enhance the anisotropic friction properties of a 1-D and 2-D wrinkling patterned surface. For a 1-D wrinkle, when sliding perpendicular to the orientation of 1-D wrinkles, wrinkles will impede the relative sliding motion due to the roughness. At the same time, under the shearing force, 1-D wrinkles can deform and bend to impede the sliding motion and therefore enhance the friction resistance. For 2-D herringbone patterns, the multiple wrinkling wavelengths provide anisotropic friction properties along different directions. In addition, the controllable jog angle can be used to manipulate the anisotropy of friction properties along different directions.

Green Antibiofouling Surface Through Wrinkling

Bio-fouling is the accumulation of living organisms, such as bacteria, fungi and algae, on a surface, onto which subsequently forms a layer of bio-films. These biofilms are often observed on the inner wall of water pipes, ship hulls incurring large drag force, and surfaces of surgical implants and devices. When found on surgical implants and devices, the biofilms cause significant healthcare problems due to infection. For antifouling, the key idea is to reduce the adhesion between the organism and the surface, and thus to inhibit bacterial colonization. Until now, most antifouling techniques were based on different chemical or biochemical treatments. Previous studies have demonstrated that the surface topology could significantly influence the level of organism adhesion, which provides a geometrical way to control the adhesion. In certain embodiments, the invention relates to a hybrid approach for antibiofouling through the manipulation of mechanically-induced wrinkled micro-patterns on coatings combined with the hydrophilic treatment of coatings with chemical methods. The geometries of the micro-patterns such as the wrinkle wavelength, wrinkle amplitude, and jog angle along with the stiffness of the coating film provide an effective way to decrease the colonization and adhesion of bacterial, which leads to an optimal surface morphology to resist the fouling of bacterial to the surface. Furthermore, in flow conditions, the micro-patterned coatings will change the boundary layers of the flow and influence the accumulation behavior of bacteria.

Altering Boundary Layers in Fluid Flow for Drag Reduction

Studies of shark skin have found that the ribbed texture of the scales of a shark leads to the reduce of drag force relative to a smooth surface due to the way that the corrugations affect the viscous boundary layer of the water. In certain embodiments, the invention relates to drag-reducing coatings with 1-D and 2-D herringbone micro-patterns. When flow is transported through the patterned coatings, the micro surface topology of the wrinkles changes the boundary layer of the water. Simulation shows that when the 1-D wrinkle is parallel to the direction of flow, it gives a relatively thinner boundary layer compared to a smooth surface. Turbulent boundary layer is found when the direction of flow is perpendicular to 1-D the wrinkles. Furthermore, the 2-D herringbone patterns with wrinkles propagating along two directions will provide a more efficient way to reduce the drag force by controlling the multiple wavelengths, amplitude, and jog angles. Additionally, more-efficient mixing of fluids will occur in proximity to surfaces with two-dimensional herringbone patterns with wrinkles propagating along two directions.

Self-Driven Movement of Water Droplet

The gradient wrinkled surface topography provides an effective way to manipulate its unbalanced surface related properties such as wetting. When a water droplet is rested on the graded wrinkling patterns, the wrinkle amplitude and wavelength are different in the front and rear locations of the water droplet, which gives a different advancing and receding contact angles. The unbalanced surface tension between the front and rear regions creates a driving force to move the water droplet to a equilibrium position. However, since the whole surface is a graded pattern, the water droplet will be driven along a certain directions, where the moving speed is dependent of the gradient wrinkling patterns.

### Dynamic Tuning of the 2-D Topography Through Stretching and Associated Properties

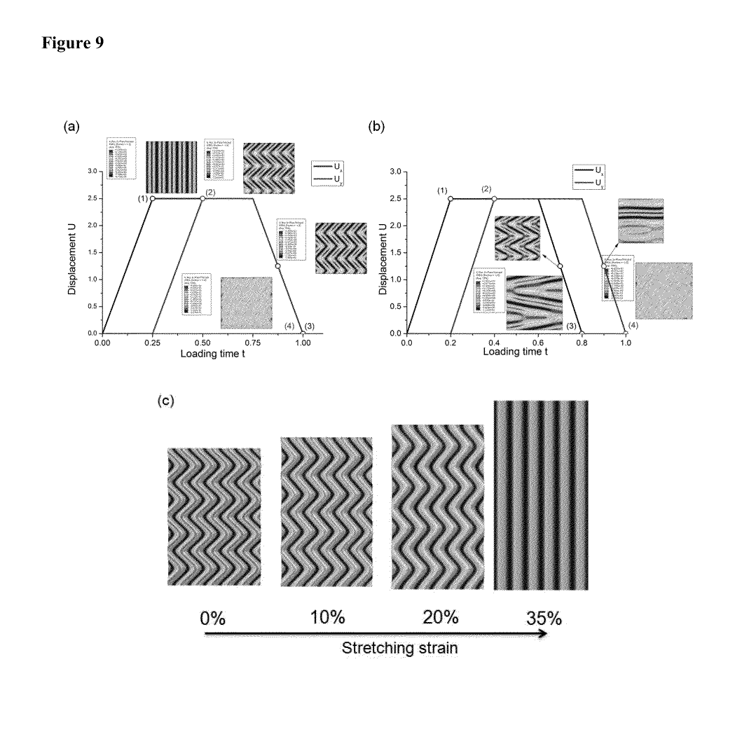

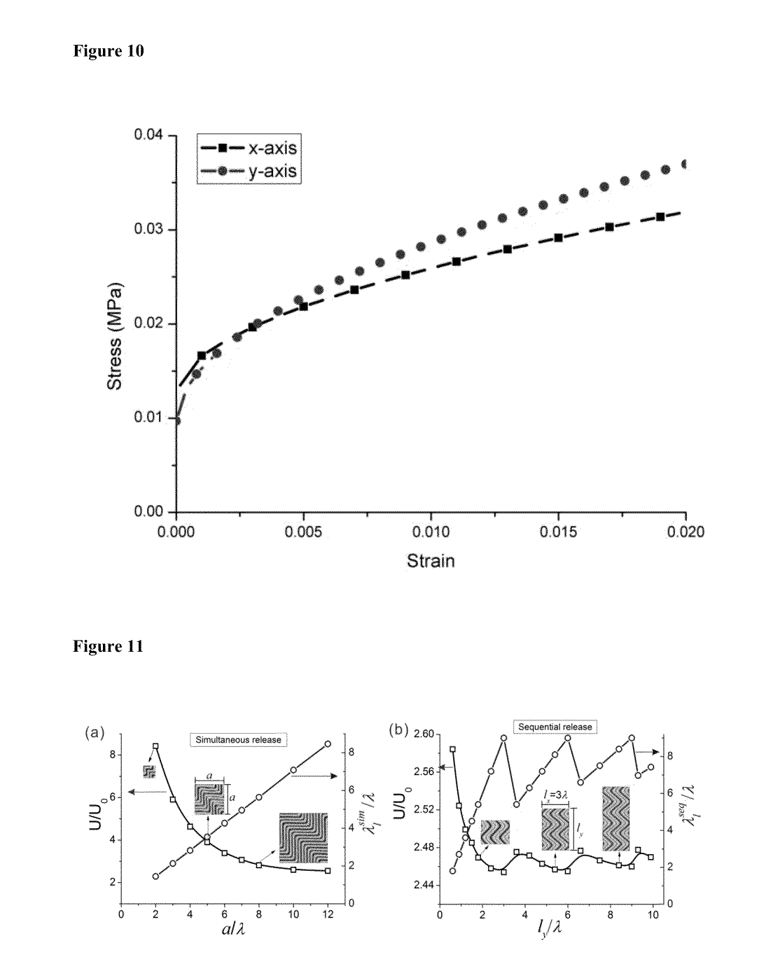

Deterministic herringbone patterns are created through sequential release of equi-biaxial prestrains. When such herringbone wrinkling patterns are reloaded (i.e., restretching) simultaneously or sequentially, it demonstrates history dependent patterns. FIG. 9 shows the comparison between simultaneous and sequential reloading of herringbone patterns, where the maximum principal stress contour of the film is shown. During the simultaneous reloading of equi-biaxial strain, the out-of-plane amplitude of herringbone decreases whereas the jog angle of 90° remains unchanged. After the strain is fully reloaded, a slightly wrinkled film with herringbone patterns remains as shown in FIG. 9a. However, upon a sequential reloading, a branched pattern is first formed after one strain is reloaded and with the reloading of the other strain the branched pattern transits to a 1D pattern and finally the film becomes flat upon full reloading as shown in FIG. 9b and the strain energy in the system is decreased to be close to 0.

When stretching the wrinkled herringbone along the direction of zig-zag wrinkles, it is found that the jog angle is increasing from 90° to 180°, where the 2-D herringbone is transited to a 1-D wrinkle. In addition, the longer wavelength increases as the stretching strain increases. The stretching strain can be controlled by actuations to stretch out the wrinkles and thus manipulating the different wrinkling morphologies, which provides a cost-effective way to tuning the surface properties related applications discussed above such as OLED, wetting, friction, and adhesions etc.

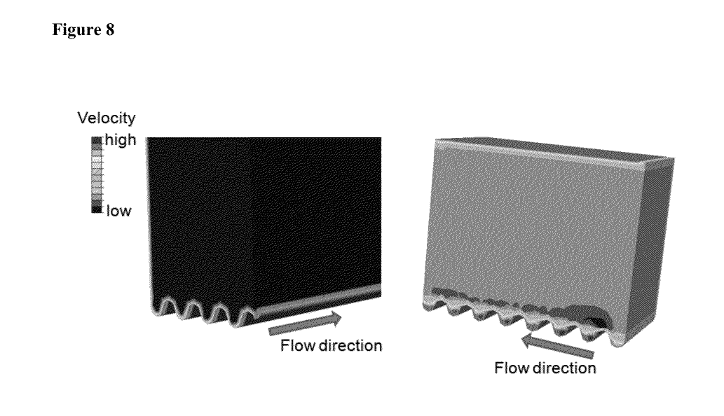

In addition to the pattern evolution with the stretching strain, as a structure, when subjected to uni-axial stretching, the wrinkling patterns show different mechanical response along two directions. FIG. 8 shows that for the herringbone patterns created through sequential release of equi-biaxial prestrains (FIG. 1b), at the beginning of stretching, the responses along two directions are very similar. However, as the stretching increases, the herringbone pattern exhibits a larger stiffness or Young's modulus along y-axis (≈1.13 MPa), i.e., direction perpendicular to the orientation of zig-zag wrinkles than that along x-axis (≈0.85 MPa), i.e., direction along the orientation of zig-zag wrinkle.

### Dynamic Tuning to Reversibly Modify Topography

In certain embodiments, the invention relates to the ability to dynamically tune the surface micro-topography of 2D deterministic herringbone patterns. In situ optical profilometry over the entire duration of the strain/release process revealed the 2D wrinkling mechanism responsible for the formation of herringbone patterns, particularly those with a jog angle lower than 90°. Moreover, the process is repeatable; that is, sequential release results in the same herringbone pattern configuration after restretching to a flat surface. In contrast, simultaneous release results in chaotic and non-reproducible patterns. Either simultaneously or sequentially restretching of a chaotic pattern does not produce a flat surface. Fourier Transform (FT) analysis of the images has been used to study the ordering of the pattern. Ordered patterns show frequencies following the periodicity of the sample. While for those non-ordered, FT shows a diffuse, isotropic range of frequencies.

In certain embodiments, the ability to reversibly modify the topography by applying a stress on a substrate can provide surfaces where mechanical bendability is a requirement. Mechanical strain or other actuators can be used to dynamically tune the pattern and its corresponding surface properties actively during use. For example, reversible wrinkled-to-flat surfaces could be used to provide bonding or adhesion with quick-release capability, or to actively alter a surface's reflectivity or wettability, and so on. Furthermore, the match between simulation and experiments confirms the reproducibility of the process and can help to design the desired surface on demand.

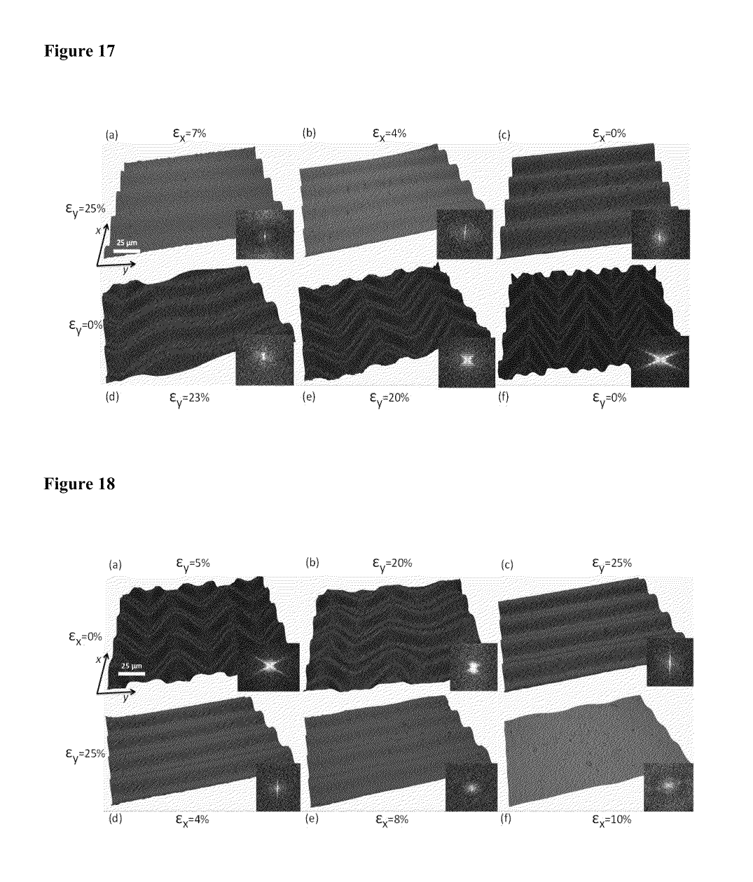

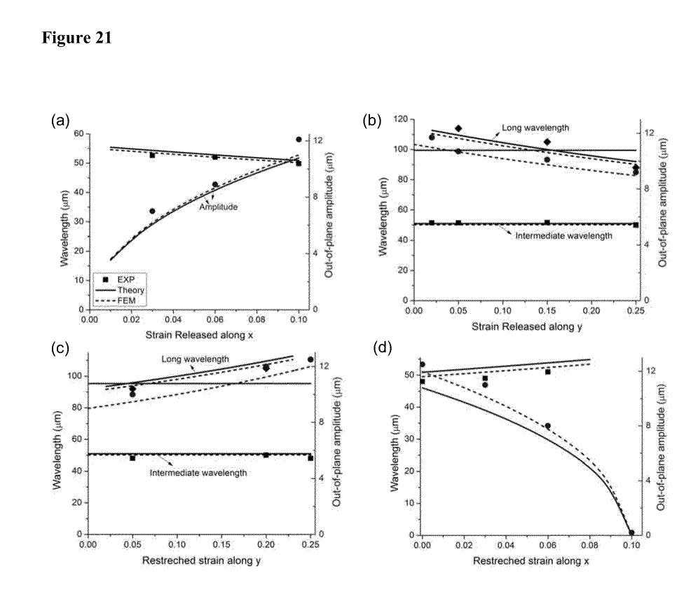

FIG. 17 displays the sequential release of a biaxially stretched sample along two directions, where the thickness of p(EGDA) coating is about 400 nm and the PDMS is prestretched to a strain of about 10% along x-direction and about 25% along y-direction. FIGS. 17a-17c correspond to the progressive release of the pre-strain along the x-axis. After release of a strain of 3% (FIG. 17a), the characteristic sinusoidal shape for 1D wrinkles can be observed with a measured wrinkle wavelength (λ) and amplitude (A) of 52.4 μm and 7 μm, respectively. The evolution of the 1D wrinkle pattern with increasing released strain along x-axis is shown in FIGS. 17b and 17c. The wrinkle wavelength 2 decreases slightly from 52.4 μm to 49.8 μm but the amplitude A increases aggressively from 7 μm to 12.1 μm after total release of the x-axis stretching (FIG. 21a).

FIGS. 17d, 17e and 17f show the evolution of the topography after release of a strain of 2%, 5% and 25% in the y-axis, respectively. In FIG. 17d, the compressive force is applied perpendicular to the first formed sinusoidal-shaped wrinkles, which bends the 1-D wrinkle into a 2-D zig-zag herringbone pattern upon further strain release (FIGS. 17e and 170. The geometry of herringbone structures can be characterized by the jog angle (α), and the intermediate (λₘ) and long wavelength (λₗ). λₘ and λₗ are the distance between two adjacent jogs in the y-axis and x-axis, respectively. As shown in FIGS. 17e and 17f, λₗ decreases from 114 μm to 88 μm (FIG. 21b), and α decreases from 100° to 62°. In contrast, λₘ, which is equal to the wavelength λ in the 1-D wrinkle, keeps steady at 50 μm (FIG. 21b). The shortening of λₗ stems from the increasing compressive stress along the y-axis in the coating. The amplitude A decreases slightly from 12 μm to 9 μm.

In addition, the 2-D FT is given as an inset for each sample in FIG. 17 to show the periodicity of the structure. The white dots correspond to the frequency of the wave and its harmonics, which displays the same orientation as the pattern. Therefore, for 1-D patterns (FIGS. 17a, 17b and 17c), the frequency is displayed vertically, while for the 2-D patterns (FIGS. 17e and 17f), the frequencies are displayed in an x-shape orientation, similarly to the zig-zag features. It should be noted that when there is no a clear periodic component, the FT analysis shows a diffused range of frequencies (FIG. 17d).

Furthermore, the zig-zag herringbone wrinkled pattern is sequentially re-stretched to its initial state with 10% strain along x-direction and 25% strain along y-direction. FIG. 18 shows the evolution of wrinkled surface topography with sequential restretching. FIGS. 18a, 18b and 18c show the transition from the 2-D wrinkled pattern to the 1-D pattern upon restretching along y-axis to a strain of 25%. The measurement of the wrinkle wavelength and amplitude shows that λₘ remains almost constant with a value of around 50 μm and amplitude A increases slightly from 9 μm to 12 μm (FIG. 21c), matching with the amplitude observed in the release process. Furthermore, after restretching along x-axis to its original strain of 10% (FIGS. 18d, 18e and 18f), amplitude A of the sinusoidal wrinkle decreases (FIG. 21d) until no evidences of the instability is observed on the coating surface (FIG. 18f). The isotropic frequencies displayed in the corresponding FT image confirm the lack of periodicity. Since there is no stress applied, the system returns to its initial state yielding a flat surface again. Thus, the present finding demonstrates that patterns with different geometries can be displayed alternately by tuning the stretch or release of the mechanical stress applied.

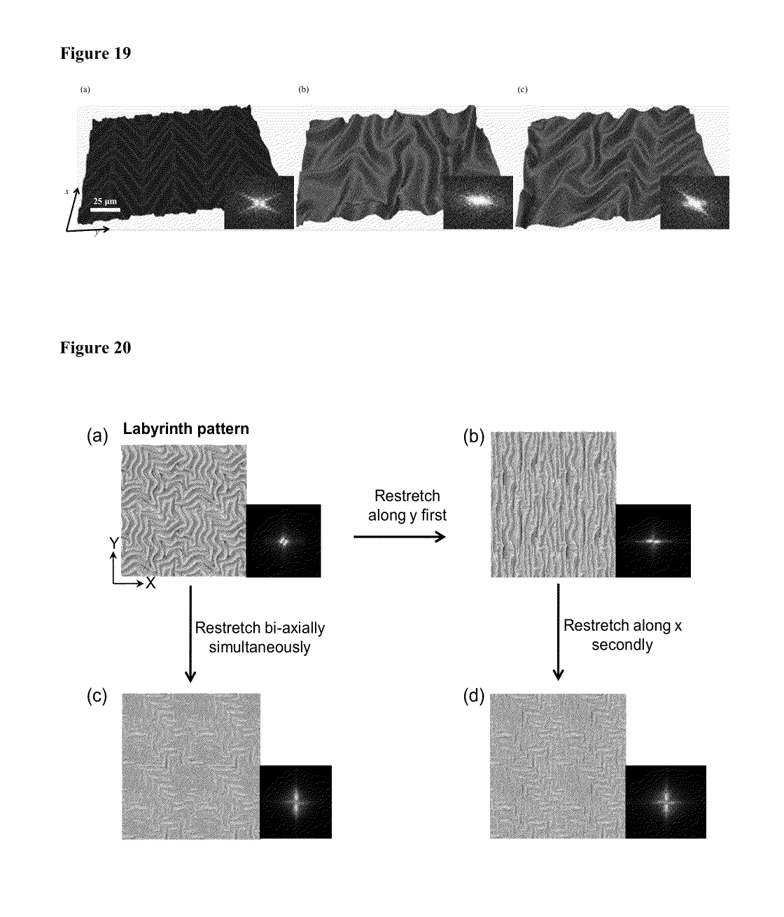

Additionally, after the same another cycle of release-restretch, the flat surface transits into the same herringbone pattern as shown in FIG. 19a. We hypothesize that reversibility in the wrinkling process is due to achieving a quasi-equilibrium state on the surface. When loading and releasing the sample, wrinkles follow an energetically reversible path that allows for switching the topology back and forth. Thus, this favorable path is the responsible for the dynamic control of the pattern. In contrast, simultaneous release of the same sample leads to a chaotic pattern (FIG. 19b) and when the same stretch-release process is carried out a different chaotic pattern is obtained (FIG. 19c). Simultaneous release does not allow reaching the minimum strain energy. Therefore, the system loses its “memory” to achieve the same final geometry since there are many plausible energetic paths to follow during the release.

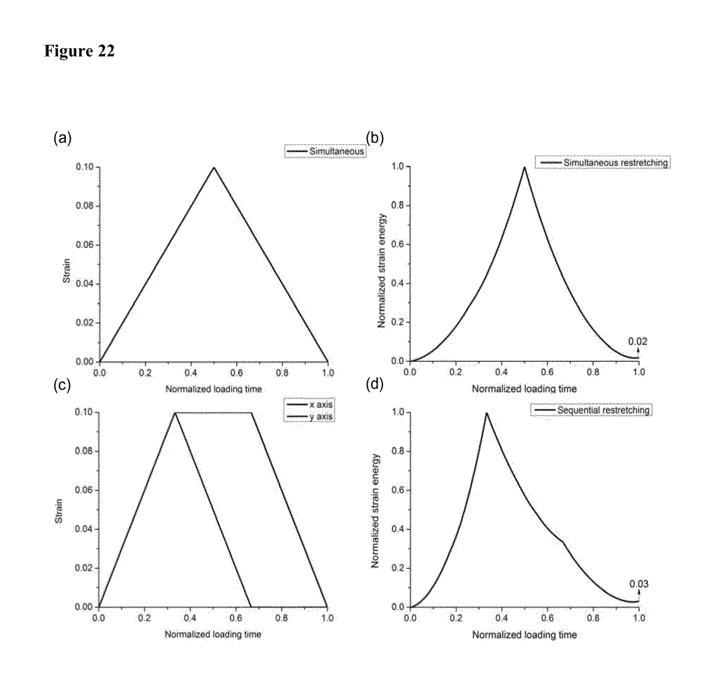

A more chaotic pattern can be obtained upon simultaneous release of equi-biaxial stretch of 10%, as shown in FIG. 20a. In contrast to the reversible surface (from flat to zig-zag herringbone pattern) after sequential restretch, FIGS. 20c and 20d show that restretching a labyrinth pattern to its original prestrain 10% either simultaneously (FIG. 20c) or sequentially (FIG. 20d) does not bring back a flat surface but results in a similar herringbone-like pattern with small out-of-plane amplitude. The strain energy remained in the film is about 2% of energy in the labyrinth pattern after simultaneously restretching and about 3% after sequentially restretching, respectively (FIG. 22). During the simultaneous restretch, the labyrinth pattern is preserved while its out-of-plane amplitude continuously decreases. When the pattern is restretched to the initial value of 10%, the chaotic pattern transits to a herringbone patter, with a small amplitude and showing a short wavelength equal to the one in the labyrinth pattern.

The evolution of wrinkling patterns during the strain releasing and restretching is simulated using FEM method and analytically modeled. FIG. 16 shows the evolution of simulated reversible wrinkling patterns from flat surface to 2-D zig-zag morphology upon unloading and reloading, which agrees well with the experimental observations (FIG. 17 and FIG. 18). Quantitative comparison of wrinkle wavelength and amplitude between simulation and experiments were studied more in detail.

The wrinkle wavelength and amplitude are associated to the material properties of the polymer coating and the PDMS substrate, the coating thickness, and the strain applied to the coating. During the release of the first straine (ε^{1st}), 1D sinusoidal wrinkles are formed, and are characterized by a wavelength (λ) and an amplitude (A) given by

$$λ = \frac{2 π {t ( {\overline{E}}_{f} / 3 {\overline{E}}_{s} )}^{\frac{1}{3}}}{1 + {ɛ}^{1 st}} , A = \frac{t \sqrt{{ɛ}^{1 st} / {ɛ}_{cr} - 1}}{\sqrt{1 + {ɛ}^{1 st}}} \qquad ( 9 )$$

Where t is the coating thickness, Ē is −E/(1−ν²) with E being the Young's modulus and ν being the Poisson's ratio and subscripts s and f refer to substrate and film, respectively. The critical buckling strain (ε_{cr}) ε_{cr}=−(3Ēₛ/Ē_{f})^{2/3}/4, for the p(EGDA)-PDMS system, was found to be 0.37%. For the 2D zig-zag herringbone pattern upon release of the second strain (ε^{2nd}) the intermediate wavelength (λₘ), long wavelength (λₗ), and amplitude (A′) are calculated based on the model in J. Yin, et al. Adv Mater 2012, 24, 5441,

$${λ}_{m} = λ , {λ}_{l} = 2.06 π {t ( 1 - {v}_{f}^{2} )}^{\frac{1}{4}} {( \frac{{\overline{E}}_{f}}{3 {\overline{E}}_{s}} )}^{\frac{1}{2}} \frac{1}{1 + {ɛ}^{2 nd}} , {A}^{′} = A \qquad ( 10 )$$

where λₘ and A′ are equal to the wrinkle length λ and amplitude A of the 1D wrinkles in Eq. (9), respectively. Eq. (9) and Eq. (10) also work for the corresponding wavelength and amplitude upon restretching of wrinkles.

FIG. 21 shows the comparison of amplitude and wavelengths obtained during the release and restretch process using analytical models (Eq. 9 and Eq. 10), FEM simulations and experiments. For both 1D and 2D wrinkles formed during the release and restretch of the strain, the corresponding wavelengths obtained from theoretical models agree well with experiments. For 2D wrinkles obtained at small strains, theoretical models predict a constant value of the amplitude. However, during the release of a relatively large strain (i.e. 25%) along y-axis, the amplitude decreases slightly with the increasing strain released. This tendency is observed both in experiments and simulations (FIGS. 21b and 21c).

### Initiated Chemical Vapor Deposition

Materials-processing often involves the deposition of films or layers on a surface of a substrate. One manner of effecting the deposition of such films or layers is through chemical vapor deposition (CVD). CVD involves a chemical reaction of vapor phase chemicals or reactants that contain the constituents to be deposited on the substrate. Reactant gases are introduced into a reaction chamber or reactor, and are decomposed and reacted at a heated surface to form the desired film or layer.

One method of CVD is initiated CVD (iCVD). In an iCVD process, thin filament wires are heated, thus supplying the energy to fragment a thermally-labile initiator, thereby forming a radical at moderate temperatures. The use of an initiator not only allows the chemistry to be controlled, but also accelerates film growth and provides control of molecular weight and rate. The energy input is low due to the low filament temperatures, but high growth rates may be achieved. The process progresses independent from the shape or composition of the substrate, is easily scalable, and easily integrated with other processes.

In certain embodiments, iCVD takes place in a reactor. In certain embodiments, a variety of monomer species may be polymerized and deposited by iCVD; these monomer species are well-known in the art. In certain embodiments, the surface to be coated is placed on a stage in the reactor and gaseous precursor molecules are fed into the reactor; the stage may be the bottom of the reactor and not a separate entity. In certain embodiments, a variety of carrier gases are useful in iCVD; these carrier gases are well-known in the art.

In certain embodiments, the iCVD reactor has automated electronics to control reactor pressure and to control reactant flow rates. In certain embodiments, any unreacted vapors may be exhausted from the system.

In certain embodiments, the iCVD coating process can take place at a range of pressures from atmospheric pressure to low vacuum. In certain embodiments, the pressure is less than about 50 torr. In certain embodiments, the pressure is less than about 40 torr. In certain embodiments, the pressure is less than about 30 torr. In certain embodiments, the pressure is less than about 20 torr. In certain embodiments, the pressure is less than about 10 torr. In certain embodiments, the pressure is less than about 5 torr. In certain embodiments, the pressure is less than about 1 torr. In certain embodiments, the pressure is less than about 0.7 torr. In certain embodiments, the pressure is less than about 0.4 torr. In certain embodiments, the pressure is about 50 torr. In certain embodiments, the pressure is about 40 torr. In certain embodiments, the pressure is about 30 torr. In certain embodiments, the pressure is about 20 torr. In certain embodiments, the pressure is about 10 torr. In certain embodiments, the pressure is about 5 torr. In certain embodiments, the pressure is about 1 torr. In certain embodiments, the pressure is about 0.7 torr. In certain embodiments, the pressure is about 0.4 torr. In certain embodiments, the pressure is about 0.2 torr. In certain embodiments, the pressure is about 0.1 torr. In certain embodiments the pressure is about 1 torr; about 0.9 torr; about 0.8 torr; about 0.7 torr; about 0.6 torr; about 0.5 torr; about 0.4 torr; about 0.3 torr; about 0.2 torr; or about 0.1 torr. In certain embodiments, the pressure is greater than about 1 mtorr.

In certain embodiments, the flow rate of the monomer can be adjusted in the iCVD method. In certain embodiments, the monomer flow rate is about 100 sccm (standard cubic centimeters per minute). In certain embodiments, the monomer flow rate is about 90 sccm. In certain embodiments, the monomer flow rate is about 80 sccm. In certain embodiments the monomer flow rate is about 70 sccm. In certain embodiments, the monomer flow rate is about 60 sccm. In certain embodiments, the monomer flow rate is about 50 sccm. In certain embodiments, the monomer flow rate is about 40 sccm. In certain embodiments, the monomer flow rate is about 30 sccm. In certain embodiments, the monomer flow rate is about 20 sccm. In certain embodiments, the monomer flow rate is less than about 100 sccm. In certain embodiments, the monomer flow rate is less than about 90 sccm. In certain embodiments, the monomer flow rate is less than about 80 sccm. In certain embodiments, the monomer flow rate is less than about 70 sccm. In certain embodiments, the monomer flow rate is less than about 60 sccm. In certain embodiments, the monomer flow rate is less than about 50 sccm. In certain embodiments, the monomer flow rate is less than about 40 sccm. In certain embodiments, the monomer flow rate is less than about 30 sccm. In certain embodiments, the monomer flow rate is less than about 20 sccm. In certain embodiments, the monomer flow rate is about 15 sccm. In certain embodiments, the flow rate is less than about 15 sccm. In certain embodiments, the monomer flow rate is about 14 sccm. In certain embodiments, the flow rate is less than about 14 sccm. In certain embodiments, the monomer flow rate is about 13 sccm. In certain embodiments, the flow rate is less than about 13 sccm. In certain embodiments, the monomer flow rate is about 12 sccm. In certain embodiments, the flow rate is less than about 12 sccm. In certain embodiments, the monomer flow rate is about 11 sccm. In certain embodiments, the flow rate is less than about 11 sccm. In certain embodiments, the monomer flow rate is about 10 sccm. In certain embodiments, the flow rate is less than about 10 sccm. In certain embodiments, the monomer flow rate is about 9 sccm. In certain embodiments, the flow rate is less than about 9 sccm. In certain embodiments, the monomer flow rate is about 8 sccm. In certain embodiments, the flow rate is less than about 8 sccm. In certain embodiments, the monomer flow rate is about 7 sccm. In certain embodiments, the flow rate is less than about 7 sccm. In certain embodiments, the monomer flow rate is about 6 sccm. In certain embodiments, the flow rate is less than about 6 sccm. In certain embodiments, the monomer flow rate is about 5 sccm. In certain embodiments, the flow rate is less than about 5 sccm. In certain embodiments, the monomer flow rate is about 3 sccm. In certain embodiments, the flow rate is less than about 3 sccm. In certain embodiments, the monomer flow rate is about 1.5 sccm. In certain embodiments, the flow rate is less than about 1.5 sccm. In certain embodiments, the monomer flow rate is about 0.75 sccm. In certain embodiments, the flow rate is less than about 0.75 sccm. In certain embodiments, the monomer flow rate is about 0.6 sccm. In certain embodiments, the flow rate is less than about 0.6 sccm. In certain embodiments, the monomer flow rate is about 0.5 sccm. In certain embodiments, the flow rate is less than about 0.5 sccm. When more than one monomer is used (i.e., to deposit co-polymers), the flow rate of the additional monomers, in certain embodiments, may be the same as those presented above.

In certain embodiments, the temperature of the monomer can be adjusted in the iCVD method. In certain embodiments, the monomer can be heated and delivered to the chamber by a heated mass flow controller. In certain embodiments, the monomer can be heated and delivered to the chamber by a needle valve. In certain embodiments, the monomer is heated at about 30° C., about 35° C., about 40° C., about 45° C., about 50° C., about 55° C., about 60° C., about 65° C., about 70° C., about 75° C., about 80° C., about 85° C., about 90° C., about 95° C., or about 100° C.

In certain embodiments, the flow rate of the initiator can be adjusted in the iCVD method. In certain embodiments the initiator flow rate is about 100 sccm. In certain embodiments, the initiator flow rate is about 90 sccm. In certain embodiments, the initiator flow rate is about 80 sccm. In certain embodiments, the initiator flow rate is about 70 sccm. In certain embodiments, the initiator flow rate is about 60 sccm. In certain embodiments, the initiator flow rate is about 50 sccm. In certain embodiments, the initiator flow rate is about 40 sccm. In certain embodiments, the initiator flow rate is about 30 sccm. In certain embodiments, the initiator flow rate is about 20 sccm. In certain embodiments, the initiator flow rate is less than about 100 sccm. In certain embodiments, the initiator flow rate is less than about 90 sccm. In certain embodiments, the initiator flow rate is less than about 80 sccm. In certain embodiments, the initiator flow rate is less than about 70 sccm. In certain embodiments, the initiator flow rate is less than about 60 sccm. In certain embodiments, the initiator flow rate is less than about 50 sccm. In certain embodiments, the initiator flow rate is less than about 40 sccm. In certain embodiments, the initiator flow rate is less than about 30 sccm. In certain embodiments, the initiator flow rate is less than about 20 sccm. In certain embodiments, the initiator flow rate is about 10 sccm. In certain embodiments, the flow rate is less than about 10 sccm. In certain embodiments, the initiator flow rate is about 5 sccm. In certain embodiments, the flow rate is less than about 5 sccm. In certain embodiments, the initiator flow rate is about 3 sccm. In certain embodiments, the flow rate is less than about 3 sccm. In certain embodiments, the initiator flow rate is about 1.5 sccm. In certain embodiments, the flow rate is less than about 1.5 sccm. In certain embodiments, the initiator flow rate is about 0.75 sccm. In certain embodiments, the flow rate is less than about 0.75 sccm. In certain embodiments, the initiator flow rate is about 0.5 sccm. In certain embodiments, the flow rate is less than about 0.5 sccm. In certain embodiments, the initiator flow rate is about 0.4 sccm. In certain embodiments, the flow rate is less than about 0.4 sccm. In certain embodiments, the initiator flow rate is about 0.3 sccm. In certain embodiments, the flow rate is less than about 0.3 sccm. In certain embodiments, the initiator flow rate is about 0.2 sccm. In certain embodiments, the flow rate is less than about 0.2 sccm. In certain embodiments, the initiator flow rate is about 0.1 sccm. In certain embodiments, the flow rate is less than about 0.1 sccm. In certain embodiments, a variety of initiators are useful in iCVD; these initiators are well-known in the art.

In certain embodiments, the carrier gas is an inert gas. In certain embodiments, the carrier gas is nitrogen or argon.

In certain embodiments, the flow rate of the carrier gas can be adjusted in the iCVD method. In certain embodiments, the carrier gas flow rate is about 1000 sccm. In certain embodiments, the carrier gas flow rate is about 900 sccm. In certain embodiments, the carrier gas flow rate is about 800 sccm. In certain embodiments, the carrier gas flow rate is about 700 sccm. In certain embodiments, the carrier gas flow rate is about 600 sccm. In certain embodiments, the carrier gas flow rate is about 500 sccm. In certain embodiments, the carrier gas flow rate is about 400 sccm. In certain embodiments, the carrier gas flow rate is about 300 sccm. In certain embodiments, the carrier gas flow rate is about 200 sccm. In certain embodiments, the carrier gas flow rate is about 100 sccm. In certain embodiments, the carrier gas flow rate is about 90 sccm. In certain embodiments, the carrier gas flow rate is about 80 sccm. In certain embodiments, the carrier gas flow rate is about 70 sccm. In certain embodiments, the carrier gas flow rate is about 60 sccm. In certain embodiments, the carrier gas flow rate is about 50 sccm. In certain embodiments, the carrier gas flow rate is about 40 sccm. In certain embodiments, the carrier gas flow rate is about 30 sccm. In certain embodiments, the carrier gas flow rate is about 20 sccm. In certain embodiments, the carrier gas flow rate is less than about 1000 sccm. In certain embodiments, the carrier gas flow rate is less than about 900 sccm. In certain embodiments, the carrier gas flow rate is less than about 800 sccm. In certain embodiments, the carrier gas flow rate is less than about 700 sccm. In certain embodiments, the carrier gas flow rate is less than about 600 sccm. In certain embodiments, the carrier gas flow rate is less than about 500 sccm. In certain embodiments, the carrier gas flow rate is less than about 400 sccm. In certain embodiments, the carrier gas flow rate is less than about 300 sccm. In certain embodiments, the carrier gas flow rate is less than about 200 sccm. In certain embodiments, the carrier gas flow rate is less than about 100 sccm. In certain embodiments, the carrier gas flow rate is less than about 90 sccm. In certain embodiments, the carrier gas flow rate is less than about 80 sccm. In certain embodiments, the carrier gas flow rate is less than about 70 sccm. In certain embodiments, the carrier gas flow rate is less than about 60 sccm. In certain embodiments the carrier gas flow rate is less than about 50 sccm. In certain, embodiments the carrier gas flow rate is less than about 40 sccm. In certain embodiments, the carrier gas flow rate is less than about 30 sccm. In certain embodiments, the carrier gas flow rate is less than about 20 sccm. In certain embodiments, the carrier gas flow rate is about 10 sccm. In certain embodiments, the flow rate is less than about 10 sccm. In certain embodiments, the carrier gas flow rate is about 5 sccm. In certain embodiments, the flow rate is less than about 5 sccm. In certain embodiments, the flow rate is greater than about 4 sccm.

In certain embodiments, the temperature of the filament can be adjusted in the iCVD method. In certain embodiments the temperature of the filament is about 350° C. In certain embodiments the temperature of the filament is about 300° C. In certain embodiments the temperature of the filament is about 250° C. In certain embodiments the temperature of the filament is about 245° C. In certain embodiments the temperature of the filament is about 235° C. In certain embodiments the temperature of the filament is about 225° C. In certain embodiments the temperature of the filament is about 200° C. In certain embodiments the temperature of the filament is about 150° C. In certain embodiments the temperature of the filament is about 100° C.

In certain embodiments, the filament is about 0.1 cm to about 20 cm from the substrate stage. In certain embodiments, the filament is about 0.1 cm, about 0.2 cm, about 0.3 cm, about 0.4 cm, about 0.5 cm, about 0.6 cm, about 0.7 cm, about 0.8 cm, about 0.9 cm, about 1.0 cm, about 1.1 cm, about 1.2 cm, about 1.3 cm, about 1.4 cm, about 1.5 cm, about 1.6 cm, about 1.7 cm, about 1.8 cm, about 1.9 cm, about 2.0 cm, about 2.1 cm, about 2.2 cm, about 2.3 cm, about 2.4 cm, about 2.5 cm, about 3.0 cm, about 3.5 cm, about 4.0 cm, about 4.5 cm, about 5.0 cm, about 5.5 cm, about 6.0 cm, about 6.5 cm, about 7.0 cm, about 7.5 cm, about 8.0 cm, about 8.5 cm, about 9.0 cm, about 9.5 cm, about 10 cm, about 11 cm, about 12 cm, about 13 cm, about 14 cm, about 15 cm, about 16 cm, about 17 cm, about 18 cm, about 19 cm, or about 20 cm from the substrate stage. In certain embodiments, the filament is about 1.4 cm from the substrate stage.

In certain embodiments, the filament is oriented in any orientation with respect to the substrate stage or the chamber. In certain embodiments, the filament is oriented above the substrate stage, below the substrate stage, or beside the substrate stage.

In certain embodiments, the iCVD coating process can take place at a range of temperatures of the substrate stage. In certain embodiments, the temperature of the substrate stage is ambient temperature. In certain embodiments, the temperature of the substrate stage is about 25° C.; in yet other embodiments the temperature of the substrate stage is between about 25° C. and about 100° C., or between about 0° C. and about 25° C. In certain embodiments said temperature of the substrate stage is controlled by water.

In certain embodiments, the rate of polymer deposition is about 1 micron/minute. In certain embodiments, the rate of polymer deposition is between about 1 micron/minute and about 50 nm/minute. In certain embodiments, the rate of polymer deposition is between about 10 micron/minute and about 50 nm/minute. In certain embodiments, the rate of polymer deposition is between about 100 micron/minute and about 50 nm/minute. In certain embodiments, the rate of polymer deposition is between about 1 nm/minute and about 50 nm/minute. In certain embodiments, the rate of polymer deposition is between about 10 nm/minute and about 50 nm/minute. In certain embodiments, the rate of polymer deposition is between about 10 nm/minute and about 25 nm/minute.

### Exemplary Materials

In certain embodiments, the invention relates to a composite material, wherein the composite material comprises a substrate with a coated surface; and the coated surface comprises a coating material.

In certain embodiments, the invention relates to any one of the aforementioned composite materials, wherein the coated surface is contiguous to the substrate.

In certain embodiments, the invention relates to any one of the aforementioned composite materials, wherein the coated surface is not topographically smooth. In certain embodiments, the invention relates to any one of the aforementioned composite materials, wherein the coated surface comprises topography. In certain embodiments, the invention relates to any one of the aforementioned composite materials, wherein the coated surface comprises a topographic pattern. In certain embodiments, the invention relates to any one of the aforementioned composite materials, wherein the topographic pattern is two-dimensional. In certain embodiments, the invention relates to any one of the aforementioned composite materials, wherein the topographic pattern is three-dimensional. In certain embodiments, the invention relates to any one of the aforementioned composite materials, wherein the topographic pattern is periodic. In certain embodiments, the invention relates to any one of the aforementioned composite materials, wherein the topographic pattern is periodic and graded. In certain embodiments, the wavelength is graded. In certain embodiments, the amplitude is graded. In certain embodiments, the invention relates to any one of the aforementioned composite materials, wherein the topographic pattern is a herringbone pattern. In certain embodiments, the invention relates to any one of the aforementioned composite materials, wherein the topographic pattern has at least two different periodic patterns, a first periodic pattern and a second periodic pattern. In certain embodiments, the invention relates to any one of the aforementioned composite materials, wherein the first periodic pattern and the second periodic pattern are oriented in different directions.

In certain embodiments, the features of the topographic pattern are on the order of micrometers or nanometers. In certain embodiments, the optimal feature size is to be specific to the fouling species. For example, micron-sized features (for example, wavelengths) may be useful for preventing the adhesion of spores for marine uses. Alternatively, smaller feature sizes (e.g., 10 nm) may be used to prevent adhesion of a polysaccharide biofilm.

In certain embodiments, the invention relates to any one of the aforementioned composite materials, wherein the topographic pattern is a herringbone pattern; and the herringbone pattern comprises a first wavelength (λₗ), a second wavelength (λₘ), and a third wavelength (λₛ).

In certain embodiments, the first wavelength is about 10 nm to about 10 mm. In certain embodiments, the first wavelength is about 100 nm to about 1 mm. In certain embodiments, the first wavelength is about 500 nm to about 500 μm. In certain embodiments, the first wavelength is about 1 μm to about 250 μm. In certain embodiments, the first wavelength is about 5 μm to about 100 μm. In certain embodiments, the first wavelength is about 10 nm, about 1 μm, about 10 μm, about 15 μm, about 20 μm, about 25 μm, about 30 μm, about 35 μm, about 40 μm, about 45 μm, about 50 μm, about 55 μm, about 60 μm, about 65 μm, about 70 μm, about 75 μm, about 80 μm, about 85 μm, about 90 μm, about 100 μm, about 200 μm, about 300 μm, about 400 μm, about 500 μm, about 600 μm, about 700 μm, about 800 μm, about 900 μm, about 1 mm, about 2 mm, about 5 mm, or about 10 mm.

In certain embodiments, the second wavelength is about 10 nm to about 10 mm. In certain embodiments, the second wavelength is about 50 nm to about 500 μm. In certain embodiments, the second wavelength is about 100 nm to about 250 μm. In certain embodiments, the second wavelength is about 500 nm to about 100 μm. In certain embodiments, the second wavelength is about 1 μm to about 50 μm. In certain embodiments, the second wavelength is about 10 nm, about 100 nm, about 1 μm, about 2 μm, about 3 μm, about 4 μm, about 5 μm, about 6 μm, about 7 μm, about 8 μm, about 9 μm, about 10 μm, about 15 μm, about 20 μm, about 25 μm, about 30 μm, about 35 μm, about 40 μm, about 50 μm, about 100 μm, about 1 mm, or about 10 mm.

In certain embodiments, the third wavelength is about 10 nm to about 10 mm. In certain embodiments, the third wavelength is about 50 nm to about 500 μm. In certain embodiments, the third wavelength is about 100 nm to about 250 μm. In certain embodiments, the third wavelength is about 500 nm to about 100 μm. In certain embodiments, the third wavelength is about 1 μm to about 30 μm. In certain embodiments, the third wavelength is about 1 μm to about 50 μm. In certain embodiments, the second wavelength is about 10 nm, about 100 nm, about 1 μm, about 2 μm, about 3 μm, about 4 μm, about 5 μm, about 6 μm, about 7 μm, about 8 μm, about 9 μm, about 10 μm, about 15 μm, about 20 μm, about 25 μm, about 30 μm, about 35 μm, about 40 μm, about 50 μm, about 100 μm, about 1 mm, or about 10 mm.

In certain embodiments, the invention relates to any one of the aforementioned composite materials, wherein the topographic pattern is a herringbone pattern; the herringbone pattern comprises a first wavelength (λₗ), a second wavelength (λₘ), and a third wavelength (λₛ); and the first wavelength, the second wavelength, and the third wavelength are a function of the method by which the composite material was formed.

In certain embodiments, the invention relates to any one of the aforementioned composite materials, wherein the topographic pattern is substantially present in an area from about 0.01 cm² to about 10 m². In certain embodiments, the topographic pattern is substantially present in an area from about 0.1 cm² to about 1 m². In certain embodiments, the topographic pattern is substantially present in an area from about 1 cm² to about 100 cm². In certain embodiments, the topographic pattern is substantially present in an area greater than about 1 cm².

In certain embodiments, the invention relates to any one of the aforementioned composite materials, wherein the topographic pattern is a herringbone pattern; and the herringbone pattern comprises a jog angle that is not about 90°.

In certain embodiments, the invention relates to any one of the aforementioned composite materials, wherein the topographic pattern is a herringbone pattern; and the herringbone pattern comprises a jog angle from about 0° to less than about 90°. In certain embodiments, the herringbone pattern comprises a jog angle from about 10° to less than about 90°. In certain embodiments, the herringbone pattern comprises a jog angle from about 20° to less than about 90°. In certain embodiments, the herringbone pattern comprises a jog angle from about 30° to less than about 90°. In certain embodiments, the herringbone pattern comprises a jog angle from about 40° to less than about 90°. In certain embodiments, the herringbone pattern comprises a jog angle from about 50° to less than about 90°. In certain embodiments, the jog angle is about 0°, about 1°, about 2°, about 3°, about 4°, about 5°, about 6°, about 7°, about 8°, about 9°, about 10°, about 20°, about 30°, about 40°, about 45°, about 50°, about 55°, about 60°, about 65°, about 70°, about 75°, about 80°, or about 85°.

In certain embodiments, the invention relates to any one of the aforementioned composite materials, wherein the topographic pattern is a herringbone pattern; and the herringbone pattern comprises a jog angle from greater than about 90° to less than about 180°. In certain embodiments, the jog angle is about 95°, about 100°, about 105°, about 110°, about 115°, about 120°, about 125°, about 130°, about 135°, about 140°, about 145°, about 150°, about 155°, about 160°, about 165°, about 170°, or about 175°.

In certain embodiments, the invention relates to any one of the aforementioned composite materials, wherein the topographic pattern is a herringbone pattern; and the herringbone pattern comprises a jog angle that is a function of the method by which the composite material was formed.

In certain embodiments, the invention relates to any one of the aforementioned composite materials, wherein the topographic pattern is a herringbone pattern; and the herringbone pattern comprises a lateral amplitude (Aₗ) from about 10 nm to about 10,000 μm. In certain embodiments, the herringbone pattern comprises a lateral amplitude (Aₗ) from about 10 nm to about 1,000 μm. In certain embodiments, the herringbone pattern comprises a lateral amplitude (Aₗ) from about 100 nm to about 500 μm. In certain embodiments, the herringbone pattern comprises a lateral amplitude (Aₗ) from about 100 nm to about 250 μm. In certain embodiments, the herringbone pattern comprises a lateral amplitude (Aₗ) from about 500 nm to about 100 μm. In certain embodiments, the herringbone pattern comprises a lateral amplitude (Aₗ) from about 1 μm to about 100 μm. In certain embodiments, the herringbone pattern comprises a lateral amplitude (Aₗ) from about 1 μm to about 50 μm. In certain embodiments, the herringbone pattern comprises a lateral amplitude (Aₗ) from about 1 μm to about 30 μm. In certain embodiments, the lateral amplitude is about 10 nm, about 100 nm, about 250 nm, about 500 nm, about 1 μm, about 2 μm, about 3 μm, about 4 μm, about 5 μm, about 6 μm, about 7 μm, about 8 μm, about 9 μm, about 10 μm, about 15 μm, about 20 μm, about 30 μm, about 40 μm, about 50 μm, about 100 μm, about 200 μm, about 300 μm, about 400 μm, about 500 μm, about 600 μm, about 800 μm, about 1,000 μm, or about 10,000 μm.

In certain embodiments, the invention relates to any one of the aforementioned composite materials, wherein the substrate is homogeneous, heterogeneous, or a composite.

In certain embodiments, the invention relates to any one of the aforementioned composite materials, wherein the substrate is soft. In certain embodiments, the invention relates to any one of the aforementioned composite materials, wherein the substrate is pliable or porous.

In certain embodiments, the invention relates to any one of the aforementioned composite materials, wherein the substrate comprises an elastomeric material or a thermoplastic material. In certain embodiments, the invention relates to any one of the aforementioned composite materials, wherein the substrate is a thermoplastic elastomer, a crosslinked elastomer, or a filled elastomer. In certain embodiments, the invention relates to any one of the aforementioned composite materials, wherein the substrate comprises a silicone. In certain embodiments, the invention relates to any one of the aforementioned composite materials, wherein the substrate comprises poly(dimethylsiloxane).

In certain embodiments, the invention relates to any one of the aforementioned composite materials, wherein the substrate comprises an elastomeric material; and the elastomeric material is selected from the group consisting of polyisoprene, polybutadiene, polychloroprene, isobutylene-isoprene copolymers, styrene-butadiene copolymers, butadiene-acrylonitrile copolymers, ethylene-propylene copolymers, and ethylene-vinyl acetate copolymers.

In certain embodiments, the invention relates to any one of the aforementioned composite materials, wherein the substrate has a thickness from about 0.1 mm to about 10 cm. In certain embodiments, the substrate has a thickness from about 0.1 mm to about 1 cm. In certain embodiments, the substrate has a thickness from about 0.1 mm to about 100 mm. In certain embodiments, the substrate has a thickness from about 0.1 mm to about 10 mm. In certain embodiments, the invention relates to any one of the aforementioned composite materials, wherein the substrate has a thickness of about 1 μm, about 2 μm, about 3 μm, about 4 μm, about 5 μm, about 6 μm, about 7 μm, about 8 μm, about 9 μm, about 10 μm, about 20 μm, about 30 μm, about 40 μm, about 50 μm, about 60 μm, about 70 μm, about 80 μm, about 90 μm, about 100 μm, about 0.5 mm, about 1 mm, about 1.5 mm, about 2 mm, about 2.5 mm, about 3 mm, about 3.5 mm, about 4 mm, about 4.5 mm, about 5 mm, about 6 mm, about 7 mm, about 8 mm, about 9 mm, about 10 mm, about 15 mm, about 20 mm, about 25 mm, about 30 mm, about 35 mm, about 40 mm, about 45 mm, about 50 mm, about 100 mm, about 1 cm, or about 10 cm.

In certain embodiments, the invention relates to any one of the aforementioned composite materials, wherein the coating material comprises a polymer, metal or semiconductor. In certain embodiments, the invention relates to any one of the aforementioned composite materials, wherein the coating material comprises a vinyl polymer, metal or semiconductor. In certain embodiments, the invention relates to any one of the aforementioned composite materials, wherein the coating material comprises a vinyl polymer. In certain embodiments, the invention relates to any one of the aforementioned composite materials, wherein the coating material comprises poly(ethylene glycol diacrylate), poly(ethylene glycol dimethacrylate), poly(1H,1H,2H,2H-perfluorodecyl acrylate), poly(2-hydroxyethyl methacrylate), a copolymer of poly(ethylene glycol diacrylate) and poly(1H,1H,2H,2H-perfluorodecyl acrylate), a copolymer of poly(ethylene glycol diacrylate) and poly(2-hydroxyethyl methacrylate), a copolymer of poly(1H,1H,2H,2H-perfluorodecyl acrylate) and poly(2-hydroxyethyl methacrylate, a metal (such as aluminum, copper, gold, and silver), or a semiconductor (such as silicon). In certain embodiments, the coating material comprises a metal, such as aluminum, copper, gold or silver. In certain embodiments, the coating material comprises a semiconductor, such as silicon.

In certain embodiments, the invention relates to any one of the aforementioned composite materials, wherein the coating material is any material with anti-fouling characteristics.

In certain embodiments, the invention relates to any one of the aforementioned composite materials, wherein the thickness of the coating material is substantially uniform. In certain embodiments, the invention relates to any one of the aforementioned composite materials, wherein the thickness of the coating material is uniform.

In certain embodiments, the invention relates to any one of the aforementioned composite materials, wherein the thickness of the coating material is about 1 nm to about 1 cm. In certain embodiments, the invention relates to any one of the aforementioned composite materials, wherein the thickness of the coating material is about 5 nm to about 1 cm. In certain embodiments, the invention relates to any one of the aforementioned composite materials, wherein the thickness of the coating material is about 10 nm to about 1 cm. In certain embodiments, the invention relates to any one of the aforementioned composite materials, wherein the thickness of the coating material is about 10 nm to about 100 mm. In certain embodiments, the invention relates to any one of the aforementioned composite materials, wherein the thickness of the coating material is about 10 nm to about 10 mm. In certain embodiments, the invention relates to any one of the aforementioned composite materials, wherein the thickness of the coating material is about 10 nm to about 1 mm. In certain embodiments, the invention relates to any one of the aforementioned composite materials, wherein the thickness of the coating material is about 25 nm to about 100 μm. In certain embodiments, the invention relates to any one of the aforementioned composite materials, wherein the thickness of the coating material is about 25 nm to about 10 μm. In certain embodiments, the invention relates to any one of the aforementioned composite materials, wherein the thickness of the coating material is about 25 nm to about 1 μm. In certain embodiments, the invention relates to any one of the aforementioned composite materials, wherein the thickness of the coating material is about 25 nm to about 600 nm. In certain embodiments, the invention relates to any one of the aforementioned composite materials, wherein the thickness of the coating material is about 50 nm to about 500 nm. In certain embodiments, the invention relates to any one of the aforementioned composite materials, wherein the thickness of the coating material is about 1 nm, about 2 nm, about 5 nm, about 25 nm, about 50 nm, about 60 nm, about 70 nm, about 80 nm, about 90 nm, about 100 nm, about 120 nm, about 140 nm, about 160 nm, about 180 nm, about 200 nm, about 220 nm, about 240 nm, about 260 nm, about 280 nm, about 300 nm, about 320 nm, about 340 nm, about 360 nm, about 380 nm, about 400 nm, about 420 nm, about 440 nm, about 460 nm, about 480 nm, about 500 nm, about 520 nm, about 540 nm, about 560 nm, about 580 nm, about 600 nm, about 1 μm, about 10 μm, about 100 μm, about 1 mm, about 10 mm, about 100 mm or about 1 cm.

In certain embodiments, the invention relates to any one of the aforementioned composite materials, wherein the coating material is adhered to the substrate.

In certain embodiments, the invention relates to any one of the aforementioned composite materials, wherein the composite material exhibits anti-fouling properties.

### Exemplary Methods

In certain embodiments, the invention relates to a method of making a composite material, comprising the steps of:

providing a substrate;

stretching the substrate in a first dimension and a second dimension, thereby forming a stretched substrate;

coating a surface of the stretched substrate with a material, wherein the stretched substrate is coated by initiated chemical vapor deposition or thermal deposition of the material onto the stretched substrate, thereby forming a stretched substrate with a coated surface;

releasing from the first dimension the stretch from the stretched substrate with a coated surface,

releasing from the second dimension the stretch from the stretched substrate with a coated surface, wherein releasing the stretch causes the coated surface to buckle, thereby forming a composite material with a coated surface.

In certain embodiments, the stretched substrate is coated by initiated chemical vapor deposition.

In certain embodiments, the invention relates to any one of the aforementioned methods, further comprising the step of exposing a surface of the substrate to plasma. In certain embodiments, the surface of the substrate is exposed to plasma before stretching. In certain embodiments, the surface of the substrate is exposed to plasma after stretching.

In certain embodiments, the invention relates to any one of the aforementioned methods, further comprising the step of contacting a surface of the substrate with gaseous silane. In certain embodiments, the surface of the substrate is contacted with gaseous silane before stretching. In certain embodiments, the surface of the substrate is contacted with gaseous silane after stretching. In certain embodiments, the surface of the substrate is contacted with gaseous silane after being exposed to plasma.

In certain embodiments, the invention relates to a method of making a composite material, comprising the steps of:

providing a substrate;

stretching the substrate in a first dimension and a second dimension, thereby forming a stretched substrate;

exposing a surface of the stretched substrate to plasma, thereby forming a stretched substrate with an enhanced number of radical species on its surface;

contacting with gaseous silane the surface of the stretched substrate enhanced in radical species;

coating the surface of the stretched substrate with a material, wherein the stretched substrate is coated by initiated chemical vapor deposition or thermal deposition of the material onto the stretched substrate, thereby forming a stretched substrate with a coated surface;

releasing from the first dimension the stretch from the stretched substrate with a coated surface,

releasing from the second dimension the stretch from the stretched substrate with a coated surface, wherein releasing the stretch causes the coated surface to buckle, thereby forming a composite material with a coated surface.

In certain embodiments, the stretched substrate is coated by initiated chemical vapor deposition.

In certain embodiments, the invention relates to any one of the aforementioned methods, wherein the substrate is stretched biaxially.

In certain embodiments, the invention relates to any one of the aforementioned methods, wherein the substrate is stretched from about 0.01% to about 300% in the first dimension or the second dimension. In certain embodiments, the invention relates to any one of the aforementioned methods, wherein the substrate is stretched from about 0.01% to about 200% in the first dimension or the second dimension. In certain embodiments, the invention relates to any one of the aforementioned methods, wherein the substrate is stretched from about 0.01% to about 150% in the first dimension or the second dimension. In certain embodiments, the invention relates to any one of the aforementioned methods, wherein the substrate is stretched from about 0.01% to about 100% in the first dimension or the second dimension. In certain embodiments, the invention relates to any one of the aforementioned methods, wherein the substrate is stretched from about 0.01% to about 50% in the first dimension or the second dimension. In certain embodiments, the invention relates to any one of the aforementioned methods, wherein the substrate is stretched from about 0.01% to about 45% in the first dimension or the second dimension. In certain embodiments, the substrate is stretched about 0.01%, about 0.1%, about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 40%, about 50%, about 60%, about 70%, about 80%, about 90%, about 100%, about 150%, about 200%, or about 300% in the first dimension or the second dimension. In certain embodiments, the degree of stretching in a substrate relates to the amplitude of the waves created in the final composite material, or the height of the features.

In certain embodiments, the invention relates to any one of the aforementioned methods, wherein the ratio of the stretch in the second dimension (ε^{2nd}) to the stretch in the first dimension (ε^{1st}) is about 0 to about 10, about 0.1 to about 10, or about 1 to about 5.

In certain embodiments, the invention relates to any one of the aforementioned methods, wherein the coated surface of the composite material is not topographically smooth. In certain embodiments, the invention relates to any one of the aforementioned methods, wherein the coated surface of the composite material comprises topography. In certain embodiments, the invention relates to any one of the aforementioned methods, wherein the coated surface of the composite material comprises a topographic pattern. In certain embodiments, the invention relates to any one of the aforementioned methods, wherein the topographic pattern is two-dimensional. In certain embodiments, the invention relates to any one of the aforementioned methods, wherein the topographic pattern is three-dimensional. In certain embodiments, the invention relates to any one of the aforementioned methods, wherein the topographic pattern is periodic. In certain embodiments, the invention relates to any one of the aforementioned methods, wherein the topographic pattern is a herringbone pattern. In certain embodiments, the invention relates to any one of the aforementioned methods, wherein the topographic pattern has at least two different periodic patterns, a first periodic pattern and a second periodic pattern. In certain embodiments, the invention relates to any one of the aforementioned methods, wherein the first periodic pattern and the second periodic pattern are oriented in different directions.

In certain embodiments, the invention relates to any one of the aforementioned methods, wherein the substrate is homogeneous, heterogeneous, or a composite. In certain embodiments, the invention relates to any one of the aforementioned methods, wherein the substrate is homogeneous. In certain embodiments, the invention relates to any one of the aforementioned methods, wherein the substrate is heterogeneous. In certain embodiments, the invention relates to any one of the aforementioned methods, wherein the substrate is a composite.

In certain embodiments, the invention relates to any one of the aforementioned methods, wherein the substrate is soft. In certain embodiments, the invention relates to any one of the aforementioned methods, wherein the substrate is pliable or porous.

In certain embodiments, the invention relates to any one of the aforementioned methods, wherein the substrate comprises an elastomeric material or a thermoplastic material. In certain embodiments, the invention relates to any one of the aforementioned methods, wherein the substrate is a thermoplastic elastomer, a crosslinked elastomer, or a filled elastomer. In certain embodiments, the invention relates to any one of the aforementioned methods, wherein the substrate comprises a silicone. In certain embodiments, the invention relates to any one of the aforementioned methods, wherein the substrate comprises poly(dimethylsiloxane).

In certain embodiments, the invention relates to any one of the aforementioned methods, wherein the substrate comprises an elastomeric material; and the elastomeric material is selected from the group consisting of polyisoprene, polybutadiene, polychloroprene, isobutylene-isoprene copolymers, styrene-butadiene copolymers, butadiene-acrylonitrile copolymers, ethylene-propylene copolymers, and ethylene-vinyl acetate copolymers.

In certain embodiments, the invention relates to any one of the aforementioned methods, wherein coating the surface of the substrate comprises initiated chemical vapor deposition (iCVD) of a polymer in a deposition chamber.

In certain embodiments, the invention relates to any one of the aforementioned methods, wherein the coating material comprises a polymer. In certain embodiments, the invention relates to any one of the aforementioned methods, wherein the coating material comprises poly(ethylene glycol diacrylate), poly(ethylene glycol dimethacrylate), or poly(2-hydroxyethyl methacrylate).

In certain embodiments, the invention relates to any one of the aforementioned methods, wherein the substrate is stretched using a device. In certain embodiments, the device is a sample holder. In certain embodiments, the device comprises a first set of jaws and a second set of jaws. In certain embodiments, the device comprises a first screw and a second screw. In certain embodiments, the first screw controls the stretching in the first dimension; and the second screw controls the stretching in the second dimension.

In certain embodiments, the invention relates to any one of the aforementioned methods, wherein the device is compatible with a vacuum reactor. In certain embodiments, the device is configured to fit into a reactor. In certain embodiments, the device is configured to fit into an iCVD reactor. In certain embodiments, the substrate, when housed in the device, is in contact with a surface of a stage in the reactor.

In certain embodiments, the invention relates to any one of the aforementioned methods, further comprising the steps of placing a first portion of the substrate within the first set of jaws; and placing a second portion of the substrate within the second set of jaws.

In certain embodiments, the invention relates to any one of the aforementioned methods, further comprising the step of controlling the rate of stretching in the first dimension. In certain embodiments, the invention relates to any one of the aforementioned methods, further comprising the step of controlling the rate of stretching in the second dimension.

In certain embodiments, the invention relates to any one of the aforementioned methods, further comprising the step of controlling the rate of releasing the stretch in the first dimension. In certain embodiments, the invention relates to any one of the aforementioned methods, further comprising the step of controlling the rate of releasing the stretch in the second dimension.

In certain embodiments, the amount or rate of stretching or the amount or rate of releasing the stretch may be controlled from outside of the reactor.

In certain embodiments, the invention relates to any one of the aforementioned methods, wherein the first dimension and the second dimension are orthogonal.

In certain embodiments, mathematical or mechanical models may be used to calculate the parameters necessary to create desired patterns, shapes, and sizes on the surface of the composite material.

In certain embodiments, the invention relates to a method of determining the modulus of a coating film on any one of the aforementioned composite materials, comprising the steps of: measuring the first wavelength of the coating; and measuring the second wavelength or the third wavelength of the coating.

In certain embodiments, the invention relates to the aforementioned method of determining the modulus of a coating film on any one of the aforementioned composite materials, further comprising the steps of: calculating a ratio of the first wavelength to the second wavelength or third wavelength; and calculating the modulus from the ratio.

In certain embodiments, the invention relates to a method of measuring the thickness of a coating film on any one of the aforementioned composite materials, comprising the steps of:

measuring the first wavelength; and

measuring the second wavelength or the third wavelength.

In certain embodiments, the invention relates to the aforementioned method of measuring the thickness of a coating film on any one of the aforementioned composite materials, further comprising the steps of: calculating a ratio of the first wavelength to the second wavelength or third wavelength; calculating the modulus from the ratio; and calculating the thickness from the modulus.

### Exemplary Articles

In certain embodiments, the invention relates to an article comprising any one of the aforementioned composite materials.

In certain embodiments, the invention relates to any one of the aforementioned articles, wherein the article is a light-emitting diode (LED). In certain embodiments, the invention relates to any one of the aforementioned articles, wherein the article is an organic light-emitting diode (OLED).

In certain embodiments, the invention relates to any one of the aforementioned articles, wherein the article is a liquid crystal display (LCD).

In certain embodiments, the invention relates to any one of the aforementioned articles, wherein the article is a bright enhancement film (BEF).

In certain embodiments, the invention relates to any one of the aforementioned articles, wherein the article is a drag-reducing coating.

In certain embodiments, the invention relates to any one of the aforementioned articles, wherein the article is substantially resistant to biofouling.

### EXEMPLIFICATION

### Example 1

### Preparation of PDMS Sheet

PDMS preparation was done using the Sylgard® 184 Silicone Elastomer Kit from Dow Corning. The elastomer and curing agent were thoroughly mixed at a mass ratio of 10:1 and poured into petri dishes with a PDMS layer of about 2 mm. The petri dishes were put in a dessicator to degas for 45 minutes and then cured in an oven at 70° C. for one hour. Cross-shaped PDMS films 6-cm long and 2-mm thick were cut using Epilog® laser cutter for the experiments. The samples were placed in a home-made sample holder for biaxial stretching. Legs of the PDMS were introduced between jaws and through the use of screws stretched to a specific elongation.

### Example 2

### iCVD Deposition of Polymer Coating

A layer of trichlorovinylsilane (97%, Sigma) was used as adhesion promoter between PDMS and p(EGDA). First, a plasma oxygen treatment for PDMS surface activation was carried out in a plasma cleaner (Harrick Scientific PDC-32G) at 18 W for 30 s. Immediately, the biaxially stretched cross-shaped PDMS film was introduced in an oven at 40° C. under vacuum and exposed to trichlorovinylsilane vapours for 5 minutes.

iCVD polymerizations were conducted in a custom-built cylindrical reactor (diameter 24.6 cm and height 3.8 cm). EGDA (98%, PolySciences) was heated to 60° C. and was introduced into the reactor at a flow rate of 0.5 sccm by using regulated needle valves. Tert-butyl peroxide (TBPO) (98%, Aldrich) and nitrogen were fed into the chamber at a flow rate of 1.5 sccm and 1.0 sccm respectively through a mass flow controller (MKS Instruments). ChromAlloy O filaments (Goodfellow) were resistively heated to 260° C. The distance between the filaments and the stage was kept at 2 cm. The stage was back-cooled by water using a chiller/heater (Neslab RTE-7) and the temperature was set at 25° C. Polymer thickness was monitored in situ by laser interferometry (JDS Uniphase). After the polymer deposition, the system was released slowly and simultaneous or sequentially to obtain the desired pattern.

### Example 3

### Characterization of Mechanical Property of p(EGDA) Coating

In order to test the material properties, self-free-standing films of p(EGDA) were obtained through two steps: first, the films with certain thickness were deposited on a sacrificial layer; second, a self-free-standing film was obtained by dissolving the sacrificial layer in the deionized water. Films with 3.5 μm thickness were chosen since the films must be thick enough to be self-standing. Since those samples were very thin and brittle, a cardboard frame was used to handle them: the frame was first glued to the sample before dissolving the sacrificial layer in water. Then the cardboard frame was cut just before the test once both ends of the samples were amounted in the jaws of the Q800 DMA. 1%/min strain rate ramps were performed on EGDA films at room temperature. The measured stiffness of the p(EGDA) film is 775 MPa.

### Example 4

### Micromechanical FEM Simulation

The coating is modeled as a linear, isotropic and elastic material with the measured Young's modulus of E_{f}=775±30 MPa and a Poisson's ratio v_{f}≈0.4 of a self-standing p(EGDA) film. The PDMS substrate is a non-linear elastic elastomeric material and modeled as a hyperelastic almost incompressible Neo-Hookean material with measured Young's modulus Eₛ=0.45±0.02 MPa and Poisson's ratio vₛ=0.49.

### Example 5

### FEM Simulation Details and Deterministic Wrinkling Pattern from Enemy Insight

The FEM simulation are carried out using commercial software ABAQUS. The EGDA thin film is represented with thin shell elements and modeled as an elastic and isotropic material with the modulus and Poisson's ratio obtained from the measurement of free-standing EGDA film with thickness of 5 μm. The PDMS substrate is represented with 3D continuum elements and modeled as a neo-hookean material with modulus measured from experiments.

Using nonlinear finite element simulations, a 3D representative volume element (RVE) with periodic boundary conditions is chosen to capture the semi-infinite film/substrate system. Different 3D RVE sizes are chosen for simultaneous and sequential displacement unloading. For simultaneous release, a 3D square cuboid computational RVE is chosen with a length of a and depth of 20λ along the z-axis with λ being the wrinkle wavelength of 1D wrinkle, which is about 1000 times thicker than the film thickness to mimic the semi-infinite depth of the substrate. Periodical boundary condition (PBC) is imposed to the four rectangle faces of the RVE to mimic the semi-infinite film/substrate system. The square size is perturbed to find the minimization of the total energy density of the whole film-substrate system, which is obtained by dividing the total strain energy by the RVE volume. Since herringbone patterns are unstable at a relatively higher prestrain, a small prestrain of 1% (≈3 ε_{cr}) is chosen to calculate the energy density of herringbone patterns for different RVE size.

For sequential unloading, since there is classical solutions to the 1D sinusoidal wrinkling wavelength λ in Eq. (1), a 3D RVE with rectangle cross section is chosen, where the length along x-axis lₓ is kept constant and set to 3λ, while the length along y-axis l_{y} is perturbated to find the minimization of the total energy density of the whole film-substrate system. The small prestrain is set to be 2% for all the calculations for the energy density.

For simultaneous release of equi-biaxial prestrain, although the short wavelength is deterministic, the long wavelength λₗ has no determined value, which is confirmed by the absence of minimization of the system total strain energy density U for different RVE with square length a as shown in Figure S1a. Here the long wavelength is found to increase linearly with the RVE size a, which indicates the long wavelength is not deterministic for simultaneous release.

In contrast to the absence of minimum strain energy for different RVE size through simultaneous release, FIG. 11b clearly shows the existence of minimization of the strain energy with the increase of RVE size l_{y} (lₓ=3λ is fixed) at a determined long wavelength, where the number of long waves increases with l_{y} and the respective long wavelength shows periodicity; the minimum values correspond to the minimum strain energy density and show a determined value of about 9λ for the condition shown here. The effect of coating thickness on the long wavelength λₗ of the herringbone is further investigated through FEM simulation. RVE are chosen with the same scaling size (lₓ=3λ and l_{y}=3lₓ) for different corresponding λ. The simulation results show the same wave number for different film thickness, which reveals that λₗ is proportional to the thickness t.

### Example 6

### Evolution of Wrinkling Patterns and Lateral Bucking During the Release of Equi-Biaxial Prestrains

For simultaneous release of the equi-biaxial prestrains, at the onset of critical buckling an unstable square checkerboard pattern occurs first, which then transforms into a herringbone pattern with a jog angle of 90° by connecting dimples (FIG. 12a and FIG. 12b). With the increase of the prestrain, the ordered patterns transformed to disordered patterns as shown in FIG. 12c and FIG. 12d.

For sequential release of the equi-biaxial prestrains, during the second release of the prestrain, the jog angle decreases from 180° to 90° as the second prestrain is fully released (FIG. 12a and FIG. 12e). In contrast to the labyrinth pattern at relatively larger prestrain, sequential release induced ordered herringbone patterns persist well and the pattern remains robust with the increase of the prestrain (FIG. 12f and FIG. 12g).

During the first release of the prestrain, FIG. 12h shows that the out-of-plane amplitude of the 1D sinusoidal wrinkle Aₛ increases significantly with the release of the εₓ strain and further shows that, during the second release of the ε_{y} strain, Aₛ remains nearly unchanged even for large prestrain (e.g., εₚᵣₑ=10%). FIG. 12i shows the in-plane amplitude Aₗ (amplitude of the long wavelength) increases with the release of the ε_{y} strain (the difference in the starting points is due to the linearization of different strain by loading time). When the strain is fully released, different prestrains lead to the similar in-plane amplitude as shown in FIG. 12i. In sum, during the second release of the prestrain, the significant increase of in-plane amplitude whereas the nearly unchanged out-of-plane amplitude of the herringbone pattern indicates a lateral buckling mechanism.

Both simultaneous and sequential release of equi-biaxial prestrains leads to similar herringbone patterns with the same jog angle of 90°, however, their geometry are different even for the same film/substrate system subjected to the same pre-stretching strain. For herringbone patterns created through simultaneous unloading, the short wavelength λₛ^{sim}, the intermediate wavelength λₘ^{sim}, and the corresponding out-of-plane amplitude Aₛ^{sim} are determined, which are given by

$${λ}_{s}^{sim} = λ , {λ}_{s}^{sim} = \sqrt{2} {λ}_{s}^{sim} = \sqrt{2} λ , \\ {A}_{s}^{sim} = \frac{t}{\sqrt{1 + {ɛ}_{pre}}} \sqrt{\frac{{ɛ}_{pre}}{{ɛ}_{cr}^{equi}} - 1} \qquad ( S1 )$$

where ε_{cr}^{equal}=ε_{cr}/(1+v_{f}) is the critical buckling strain for equi-biaxial compression. λₛ^{sim} is equal to the wavelength of 1D wrinkle taking into account the finite deformation in the film.

For herringbone patterns created through sequential wrinkling, the short wavelength λₛ^{seq}, intermediate wavelength λₘ^{seq}, and its respective out-of-plane amplitude Aₛ^{seq} are determined and are given by

λₛ^{seq}≈λₘ^{seq}/\sqrt{2}=λ/\sqrt{2},λₘ^{seq}=λ,Aₛ^{seq}≈Aₛ^{sim} (S2)

where the short wavelength λₛ^{seq} is smaller than that for simultaneous release whereas the intermediate wavelength λₘ^{seq} is equal to the short wavelength λₛ^{sim} upon simultaneous unloading.

### Example 7

### Different Herringbone Patterns Upon the Simultaneous and Sequential Release of Non-Equi-Biaxial Prestrain

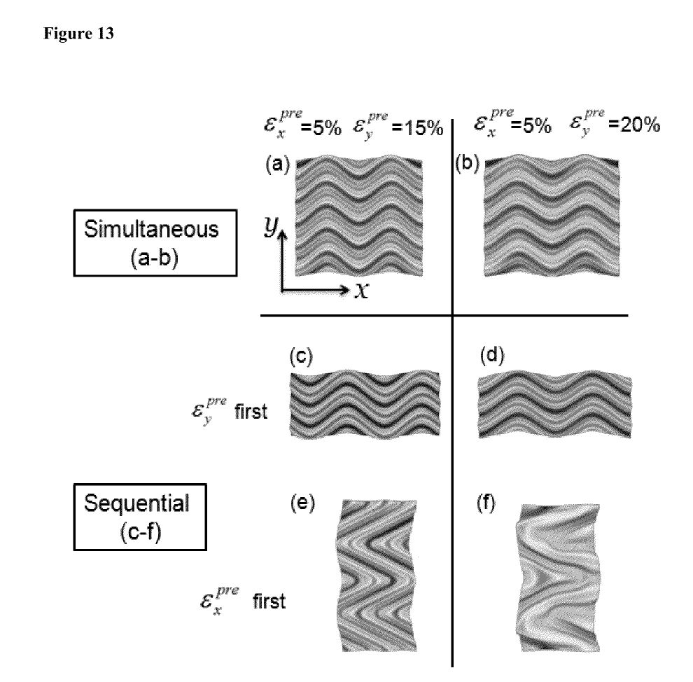

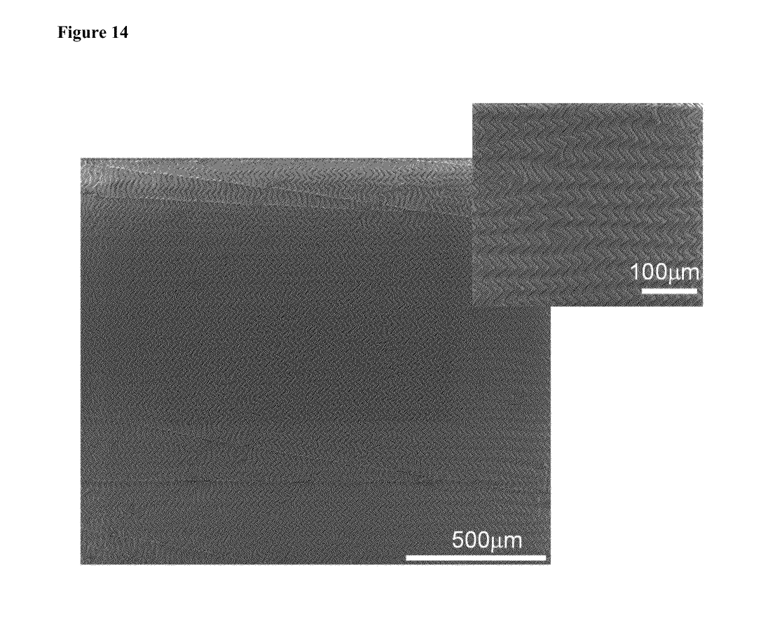

See FIG. 13 and FIG. 14.

### Example 8

### Predictive Design of 1D Wrinkled Morphologies

Eq. (2) provides a predictive way to quantitatively control the geometry of 1D wrinkled surface morphologies, which is demonstrated through the manipulation of EGDA coating thickness and the prestretching strains. The prestretching strains of up to 25% were investigated, which is more than 60 times greater than the critical buckling strain (ε_{cr}=0.37%).

FIG. 15a and FIG. 15b show the comparison between the results of experiment, the finite deformation theoretical model and FEM simulations for a coating with t=200 nm. The wrinkling wavelength decreases nearly linearly with the increase of prestrain, which agrees with Eq. (1); the experiment and models are in excellent agreement. The wrinkle amplitude deviated from the small deformation theory at small applied prestrain (≈6%≈16ε_{cr}). When finite deformation is considered, the wrinkle amplitude is slightly lower than that for small deformation and the deviation increases with the prestrain, which is confirmed by the FEM simulation and experiments.

### Example 9

### Lateral Buckling Analysis of Composite Columns on Substrates

The in-plane bending equation for the composite column on an elastic foundation can be given by

$${( EI )}_{c} \frac{{d}^{4} w ( x )}{d {x}^{4}} + N \frac{{d}^{2} w ( x )}{d {x}^{2}} + Kw ( x ) = 0 \qquad ( S3 )$$

where (EI)_{c} is the bending stiffness of the composite column with (EI)_{c}=E_{f}I_{f}+EₛIₛ, where I_{f} and Iₛ are the area moment of inertia of the film layer and substrate core of the column, respectively. For a sinusoidal cross-section shape, the bending stiffness of the composite column is approximated as E_{c}I_{c}≈0.012E_{f}t(λ^{uni})²(3A+λ^{uni})/π for E_{f}>>Eₛ with λ^{uni} and A given in Eq. (1). w(x) is the lateral in-plane deflection normal to the column axis and N is the compressive force along the column. K is the lateral stiffness of the foundation, which is related to the substrate modulus as well as the ratio of the wrinkle short wavelength λ^{uni} to long wavelength λₗ. From the Winkler foundation analysis, K can be estimated as K=φ(λ^{uni}/λₗ)Ēₛ and the unknown function φ(λ^{uni}/λₗ) is to be determined by solving the equilibrium equations of the semi-infinite substrate. Since λᵤₙᵢ is comparable to λₗ with an approximate ratio of 0.36, the value of φ depends on the ratio of λ^{uni}/λₗ and can only be solved numerically, which gives K≈2.48 Ēₛ for the ratio of 0.36.

Suppose the lateral deflection w(x) can be described by a sinusoidal form with w(x)=Aₗ cos(2πx/λₗ), where Aₗ and λₗ are the lateral amplitude and long wavelength, respectively. After the substitution of w(x) into Eq. (4) and minimization with respect to λₗ, the wrinkle wavelength and the critical buckling strain ε_{cr}^{l}, can be obtained.

### Example 10

### Dynamic Tuning of Wrinkled Patterns

Substrate Preparation

The PDMS substrate is prepared through several steps. The PDMS was synthesized using the Sylgard 184 Silicone Elastomer Kit from Dow Corning. The elastomer and the curing agent were thoroughly mixed at a mass ratio of 10:1 and poured into Petri dishes with a PDMS layer of about 2 mm. The Petri dishes were put in a vacuum dessicator for degasification during 45 minutes and then cured in an oven at 70° C. for one hour. Cross-shaped PDMS films 6 cm long and 2 mm thick were cut using an Epilog laser cutter for the experiments.

Pattern Formation

The samples were placed in a home-made sample holder for biaxial stretching. Legs of the PDMS were introduced between jaws and through the use of screws stretched to a specific elongation. PDMS was stretched 10% in the x-axis and 25% in the y-axis. After the p(EGDA) deposition, simultaneous and sequential release were conducted, where for sequential release the x-axis was released first, and then the y-axis. The release rate was approximately 10 μm·s⁻¹.

iCVD Polymerization

A layer of trichlorovinylsilane (97%, Sigma) was used as adhesion promoter between PDMS and p(EGDA). First, the PDMS surface was activated using a plasma oxygen treatment in a plasma cleaner (Harrick Scientific PDC-32G) at 18 W for 30 s. Immediately, the biaxially stretched cross-shaped PDMS film was introduced in an oven at 40° C. under vacuum and exposed to trichlorovinylsilane vapors for 5 minutes. iCVD polymerizations were conducted in a custom-built cylindrical reactor (diameter 24.6 cm and height 3.8 cm). EGDA (98%, PolySciences) was heated to 60° C. and was introduced into the reactor at a flow rate of 0.5 sccm by using a regulated needle valve. Tert-butyl peroxide (TBPO) (98%, Aldrich) was fed into the chamber at a flow rate of 1.5 sccm through a mass flow controller (MKS Instruments). ChromAlloy O filaments (Goodfellow) were resistively heated to 230° C. The distance between the filaments and the stage was kept at 2 cm. The stage was back-cooled by water using a chiller/heater (Neslab RTE-7) and the temperature was set at 25° C. Polymer thickness was monitored in situ by laser interferometry (JDS Uniphase).

Material Characterization

The dynamic evolution of the surface pattern and its features were analyzed with a 3-D optical profilometer (Zeta-20™, Zeta Instruments) at different steps of the release and restretch process.

Simulation Details

The simulation is based on Finite Element Method (FEM) using the commercial software ABAQUS. The coating is modeled as a linear, isotropic and elastic material with the measured Young's modulus of E_{f}=775±30 MPa and a Poisson's ratio v_{f}≈0.4 of a self-standing EGDA film. The PDMS substrate is a non-linear elastic elastomeric material and modeled as a hyperelastic almost incompressible Neo-Hookean material with measured Young's modulus Eₛ=0.45±0.02 MPa and Poisson's ratio vₛ=0.49.

### INCORPORATION BY REFERENCE

All of the U.S. patents and U.S. patent application publications cited herein are hereby incorporated by reference.

### EQUIVALENTS

Those skilled in the art will recognize, or be able to ascertain using no more than routine experimentation, many equivalents to the specific embodiments of the invention described herein. Such equivalents are intended to be encompassed by the following claims.

We claim:

1. A composite material, wherein the composite material comprises a substrate with a coated surface; the coated surface comprises a coating material; and the coated surface comprises a topographic pattern.

2. The composite material of claim 1, wherein the coated surface is contiguous to the substrate.

3. The composite material of claim 1, wherein the topographic pattern is periodic.

4. The composite material of claim 1, wherein the topographic pattern is a deterministic pattern.

5. The composite material of claim 1, wherein the topographic pattern has at least two different periodic patterns, a first periodic pattern and a second periodic pattern.

6. The composite material of claim 1, wherein the topographic pattern is a herringbone pattern; and the herringbone pattern comprises a first wavelength (λₗ), a second wavelength (λₘ), and a third wavelength (λₛ).

7. The composite material of claim 6, wherein the first wavelength is about 10 nm to about 10 mm.

8. The composite material of claim 6, wherein the second wavelength is about 10 nm to about 10 mm.

9. The composite material of claim 6, wherein the third wavelength is about 10 nm to about 10 mm.

10. The composite material of claim 1, wherein the topographic pattern is a herringbone pattern; and the herringbone pattern comprises a jog angle that is not about 90°.

11. The composite material of claim 1, wherein the topographic pattern is a herringbone pattern; and the herringbone pattern comprises a lateral amplitude (Aₗ) from about 10 nm to about 10,000 μm.

12. The composite material of claim 1, wherein the substrate comprises an elastomeric material or a thermoplastic material.

13. The composite material of claim 1, wherein the substrate comprises poly(dimethylsiloxane).

14. The composite material of claim 1, wherein the substrate has a thickness from about 0.1 mm to about 10 cm.

15. The composite material of claim 1, wherein the coating material comprises a vinyl polymer.

16. The composite material of claim 1, wherein the thickness of the coating material is about 1 nm to about 1 cm.

17. A method of making a wrinkled composite material, comprising the steps of:
providing a substrate;
stretching the substrate in a first dimension and a second dimension, thereby forming a stretched substrate;
coating a surface of the stretched substrate with a material, wherein the stretched substrate is coated by initiated chemical vapor deposition or thermal deposition of the material onto the stretched substrate, thereby forming a stretched substrate with a coated surface;
releasing from the first dimension the stretch from the stretched substrate with a coated surface,
releasing from the second dimension the stretch from the stretched substrate with a coated surface, wherein releasing the stretch causes the coated surface to buckle, thereby forming a composite material with a wrinkled coated surface.

18. The method of claim 17, wherein the stretched substrate is coated by initiated chemical vapor deposition of the material onto the stretched substrate.

19. A method of making a composite material, comprising the steps of:
providing a substrate;
stretching the substrate in a first dimension and a second dimension, thereby forming a stretched substrate;
exposing a surface of the stretched substrate to plasma, thereby forming a stretched substrate with an enhanced number of radical species on its surface;
contacting with a gaseous silane the surface of the stretched substrate enhanced in radical species, thereby forming a covalent bond between the silane and the substrate;
coating the surface of the stretched substrate with a material, wherein the stretched substrate is coated by initiated chemical vapor deposition or thermal deposition of the material onto the stretched substrate, thereby forming a stretched substrate with a coated surface;
releasing from the first dimension the stretch from the stretched substrate with a coated surface,
releasing from the second dimension the stretch from the stretched substrate with a coated surface, wherein releasing the stretch causes the coated surface to buckle, thereby forming a composite material with a coated surface.

20. The method of claim 19, wherein the stretched substrate is coated by initiated chemical vapor deposition of the material onto the stretched substrate.

21. The method of claim 19, wherein the substrate is stretched from about 0.01% to about 300% in the first dimension or the second dimension.

22. The method of claim 19, wherein the ratio of the stretch in the second dimension (ε^{2nd}) to the stretch in the first dimension (ε^{1st}) is about 0 to about 10.

23. An article comprising a composite material of claim 1.
